(19) United States
(12) Patent Application Publication
(10) Pub. No.: US 2016/0011752 A1
(43) Pub. Date: Jan. 14, 2016

(54) SYSTEM AND METHOD FOR PROVIDING A USER INTERFACE FOR DEVICE INSTALLATION

(71) Applicant: Verizon Patent and Licensing Inc., Arlington, VA (US)

(72) Inventors: Sakthivel SUBRAMANIAN, Chennai (IN); Dipu P. CHANDRAN, Chennai (IN); Nirmal Jeyaseelan INNACIMUTHU, Virudhunaga (IN); John V. JAYAKUMAR, Chennai (IN); Nagendra Babu NAMBURI, Kurnool (IN); Sarath Loganathan VONTIVILLU, Chennai (IN)

(21) Appl. No.: 14/326,116

(22) Filed: Jul. 8, 2014

(51) Int. Cl. G06F 3/0484; G06F 9/445; H04L 29/08

(52) U.S. Cl. CPC G06F 3/04847; H04L 67/10; G06F 8/61; H04L 67/306

(57) ABSTRACT

An approach is provided for receiving a request to present a user interface for facilitating an installation of a device, a service, or a combination thereof. The approach also involves retrieving user account information associated with the installation, wherein the user account information indicates the device, the service, or a combination thereof selected by a user. The approach further involves configuring one or more user interface elements of the user interface based on the user account information, the selected device, the selected service, or a combination thereof, wherein the one or more user interface elements include a header section, a progress navigation section, a content section, a footer section, or a combination thereof.

### BACKGROUND INFORMATION

A self-installation of a device does not require any technical skills, a user may register and activate a device by following the steps explained in the self-installation manual. Although such installation process may save the installation cost from a certified technician, such process may be cumbersome and inefficient for some users. For example, a user needs to go through several pages of the self-installation manual, and may be uncertain as to which page to read first. As a result, users are unable to identify the key steps. Consequently, users are required to restart the self-installation process due to an incorrect installation sequence.

Therefore, configuration of user interface elements for facilitating an installation of a device and/or a service is necessary for efficiency and user convenience.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of configuring one or more user interface elements for facilitating an installation of a device, a service, or a combination thereof, according to one embodiment;

FIG. 2 is a diagram of the components of the configuration platform 115, according to one embodiment;

FIG. 3 is a flowchart of a process for configuring one or more user interface elements for facilitating an installation of a device, a service, according to one embodiment;

FIG. 4 is a flowchart of a process for configuring one or more user interfaces and/or user interface elements, according to one embodiment;

FIG. 5 is a flowchart of a process for rendering several representations in the user interface for providing information to a user, according to one embodiment;

FIG. 6 is a flowchart of a process for rendering a user interface element of the user interface for providing one or more notification during a user verification process, according to one embodiment;

FIG. 7 is a user interface diagram that represents a header section, according to one example embodiment;

FIG. 8 is a user interface diagram that represents a progress navigation section, according to one example embodiment;

FIG. 9 is a user interface diagram that represents a content section layout pattern, according to one example embodiment;

FIG. 10 is a user interface diagram that represents a layout pattern for a footer section, according to one example embodiment;

FIG. 11 is a user interface diagram that represents an end user verification process by using a user's personal details and zip code information, according to one example embodiment;

FIG. 12 is a user interface diagram that represents an end user verification process by using the order number, the zip code, according to one example embodiment;

FIG. 13 is a user interface diagram that represents a navigation layout, according to one example embodiment;

FIG. 14 is a user interface diagram that represents an activation layout, according to one example embodiment;

FIG. 15 is a user interface diagram that represents a television setup layout with graphical representation of different devices the customers have ordered, according to one example embodiment;

FIG. 16 is a user interface diagram that represents a details layout for a device, according to one example embodiment;

FIG. 17 is a user interface diagram that represents an overlay of the equipment component selection, according to one example embodiment;

FIGS. 18A-18F are user interface diagrams that represent an equipment connection and activation layout, according to one example embodiment;

FIG. 18G represents a flow diagram for television equipment activation, troubleshooting navigation and user interaction, according to one example embodiment;

FIGS. 18H-18I are diagrams that represents the flow diagrams for television equipment activation, troubleshooting navigation and user interaction, according to one example embodiment;

FIGS. 19A and 19B are user interface diagrams that represents different layout for user interaction during an activation process for cable card devices, according to one example embodiment;

FIG. 20 is a user interface diagram that represents an activation process for a digital adapter, according to one example embodiment;

FIG. 21 is a user interface diagram that represents a success overlay which is presented after the user clicks/touches ‘Continue’ CTA, according to one example embodiment;

FIG. 22 is a user interface diagram that represents details of a device displayed with updates of activation, according to one example embodiment;

FIG. 23 is a user interface diagram that represents a layout for a phone setup, according to one example embodiment;

FIG. 24 is a flow diagram for phone activation, troubleshooting navigation and user interaction, according to one example embodiment;

FIGS. 25A and 25B are user interface diagrams that represents the flow diagrams for phone activation, troubleshooting navigation and user interaction, according to one example embodiment;

FIGS. 26A and 26B are user interface diagrams for software setup layout, according to one example embodiment;

FIG. 27 is a user interface diagram that represents a welcome page indicating completion of an activation process, according to one example embodiment;

FIG. 28 is a diagram of a computer system that can be used to implement various exemplary embodiments; and

FIG. 29 is a diagram of a chip set that can be used to implement various exemplary embodiments.

### DESCRIPTION OF THE PREFERRED EMBODIMENT

An apparatus, method, and software for configuring one or more user interface elements for facilitating an installation of a device, a service, or a combination thereof, is described. In the following description, for the purposes of explanation, numerous specific details are set forth in order to provide a thorough understanding of the present invention. As is well known, the present invention may be practiced without these specific details or with an equivalent arrangement. In other instances, well-known structures and devices are shown in block diagram form in order to avoid unnecessarily obscuring the present invention.

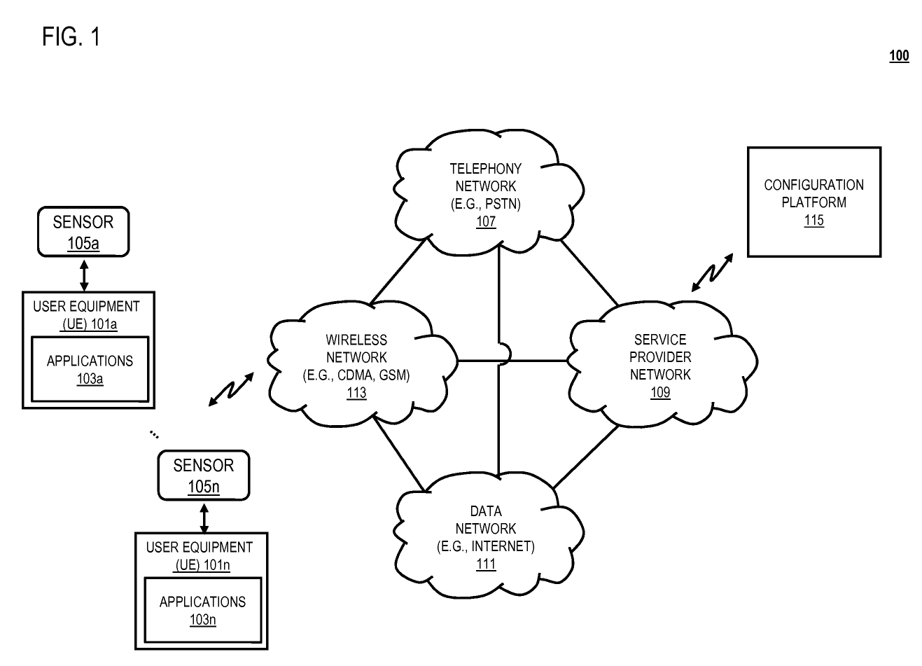

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the configuration platform 115 via networks 107-113. In one embodiment, the configuration platform 115 performs one or more functions associated with configuring one or more user interface elements for facilitating an installation of a device, a service, or a combination thereof.

As discussed earlier, one of the advantages of self-installation of a device and/or service is the opportunity to install a device without any technical knowledge. It is therefore important that the installation of a device is straightforward, inexpensive, and error free to preserve this advantage. However, a self-installation process may be unproductive for some users, for instance, a user have to read though voluminous pages of the self-installation manual and may be confused regarding the sequence of installing a device and/or a service. In addition, a user may be unable to identify the key steps for installing a device because he may not be attentive enough to read through the numerous pages of the self-installation manual. As a result, users constantly face installation glitches. Subsequently, users are either starting over the self-installation process or calling the customer services with installation queries. This undermines the objective of self-installation, hence a user interface guidance for installation of a device and/or a service is required for customer satisfaction.

In one embodiment, system 100 may be an interactive web based application that allows a user to register and install their products. In one scenario, the users are instructed to configure and connect their router with the internet enabled devices (e.g. personal computers or laptops or tablets etc.) as the first step. Once the user successfully executes the configuration and the installation of the router, system 100 may initiate a self-install application through a secured network. In one embodiment, system 100 may connect a device to a secured network. Then, system 100 may cause a presentation of a user interface element to assist a user in configuring a device to a secured network. Accordingly, system 100 causes a presentation of a user interface element to assist a user in completing a web based support tool for registration and installation of a device.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as media player applications, social networking applications, calendar applications, content provisioning services, location-based service applications, navigation applications and the like. In one embodiment, one of the applications 103 at the UE 101 may act as a client for the configuration platform 115 and may perform one or more functions associated with the functions of the configuration platform 115 by interacting with the configuration platform 115 over the networks 107-113.

By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication etc.), temporal information, a camera/imaging sensor for gathering image data, an audio recorder for gathering audio data, and the like. In one scenario, the sensors 105 may include, light sensors, oriental sensors augmented with height sensor and acceleration sensor, tilt sensors, moisture sensors, pressure sensors, audio sensors (e.g., microphone), gaze tracking sensors etc.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

In one embodiment, the configuration platform 115 may be a platform with multiple interconnected components. The configuration platform 115 may include multiple servers, intelligent networking devices, computing devices, components and corresponding software for configuring one or more user interface elements for facilitating an installation of a device, a service, or a combination thereof. In addition, it is noted that the configuration platform 115 may be a separate entity of the system 100, or included within the UE 101 (e.g., as part of the applications 103).

In one embodiment, the configuration platform 115 may receive a request to present a user interface for facilitating an installation of a device, a service, or a combination thereof. In one scenario, one or more users may choose self-installation of a device over installation by an expert. In the absence of any technical assistance, the user needs to look through the numerous pages of the guidebook. As an alternative, a user may send a request to the configuration platform 115 via their respective UE 101 for guided visual instructions for installing a device and/or a service.

In another embodiment, the configuration platform 115 may retrieve a user account information associated with the installation, wherein the user account information indicates the device, the service, or a combination thereof selected by a user. In one scenario, the configuration platform 115 upon receiving a request to present a user interface for facilitating an installation may verify user account information. The verification process may involve the configuration platform 115 retrieving user account information to determine the details for a device and/or a service.

In a further embodiment, the configuration platform 115 may configure one or more user interface elements of the user interface based on the user account information, the selected device, the selected service, or a combination thereof, wherein the one or more user interface elements include a header section, a progress navigation section, a content section, a footer section, or a combination thereof. In one embodiment, the header section may include one or more support elements that may be helpful for the at least one user during the registration process, for example, a live chat support may be provided to a user for registering and installing a product. In another embodiment, the progress navigation section is a guided visual navigation pattern that provides for iconic representation of one or more modules involved in the process of registering and installation of the at least one product. In a further embodiment, the content section layout pattern may be divided in two patterns: (a) a static content header or interactive content with visual indication of user selected options, and (b) a user interactive content area. In another embodiment, the footer section layout pattern is a placeholder for displaying help content related to a particular module for end user, for example, product related information, videos etc.

According to exemplary embodiments, end user devices may be utilized to communicate over system 100 and may include any customer premise equipment (CPE) capable of sending and/or receiving information over one or more of networks 107-113. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

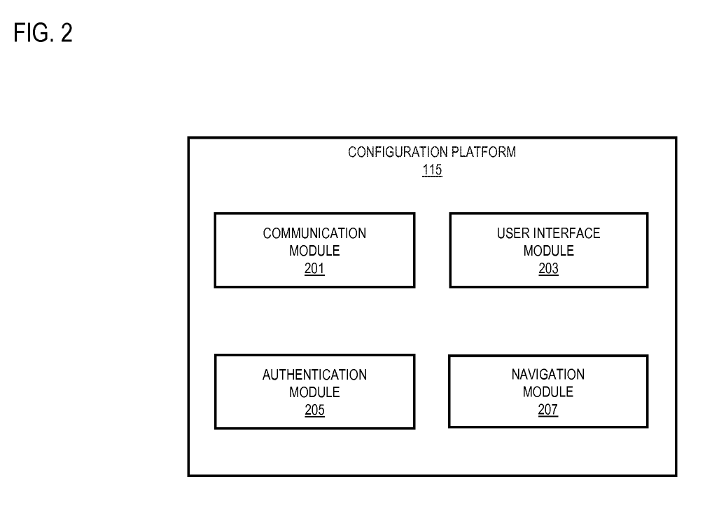

FIG. 2 is a diagram of the components of the configuration platform 115, according to one embodiment. By way of example, the configuration platform 115 includes one or more components for configuring one or more user interface elements for facilitating an installation of a device, a service, or a combination thereof. It is contemplated that the functions of these components may be combined in one or more components or performed by other components of equivalent functionality. In this embodiment, the configuration platform 115 includes a communication module 201, a user interface module 203, an authentication module 205 and a navigation module 207.

In one embodiment, the communication module 201 executes various protocols and data sharing techniques for connecting at least one device to a secured network, thereby facilitating a presentation of user interface elements to assist at least one user in configuring at least one device to a secured network. The communication module 201 may be used to communicate commands, requests, data, etc. By way of example, the communication module 201 may be used to transmit a request from a UE 101 to the configuration platform 115 for presentation of a user interface elements for facilitating an installation of a device and/or a service.

In one embodiment, the user interface module 203 employs various application programming interfaces (APIs) or other function calls corresponding to the applications 103 of UE 101, thus enabling the display of graphics primitives such as menus, data entry fields, etc., for generating the user interface elements. By way of example, the user interface module 203 generates the interface in response to APIs or other function calls corresponding to the browser application or web portal application of the UE 101, thus enabling the display of graphics primitives. In another embodiment, the user interface module 203 causes a presentation of a configuration interface to assist at least one user in configuring at least one device to a secured network. In a further embodiment, the user interface module 203 causes a presentation of a graphical user interface to at least one user to assist in completing a web based support tool for registration and installation of at least one device.

The authentication module 205 authenticates UE 101s for interaction with the configuration platform 115. In one embodiment, the authentication module 205 causes a verification of user information to configure at least one device to a secured network. In another embodiment, the authentication module 205 may detect an error during a user verification process based, at least in part, on predefined values, wherein predefined values include, at least in part, a preset username and password combination, a pin code, one or more identifiers, other authentication mechanisms, or a combination thereof. The authentication process performed by the module 205 may also include receiving and validating a login name and/or user identification value as provided or established for a particular user during a subscription or registration process with the service provider. The login name and/or user identification values may be received as input provided by the user from the UE 101 or other device via a graphical user interface to the platform 115 (e.g., as enabled by the user interface module 203). Alternatively, the login process may be performed through automated association of profile data for the user and/or UE 101 with an IP address, a carrier detection signal of a user device, mobile directory number (MDN), subscriber identity module (SIM) (e.g., of a SIM card), radio frequency identifier (RFID) tag or other identifiers.

In one embodiment, the navigation module 207 is a guided visual navigation pattern that indicates the process involved during registration and installation of a device. In another embodiment, the navigation module 207 may work in conjunction with the user interface module 203 to cause a display of one or more user interface elements as visual guidance information to at least one user on device connection, device activation, user interaction, or a combination thereof. In a further embodiment, the navigation module 207 may work in conjunction with the user interface module 203 to cause a presentation of a summary interface that allows at least one user to identify at least one device, wherein summary interface include image of the device, name of the device, model number, serial number, plurality of icons, or a combination thereof.

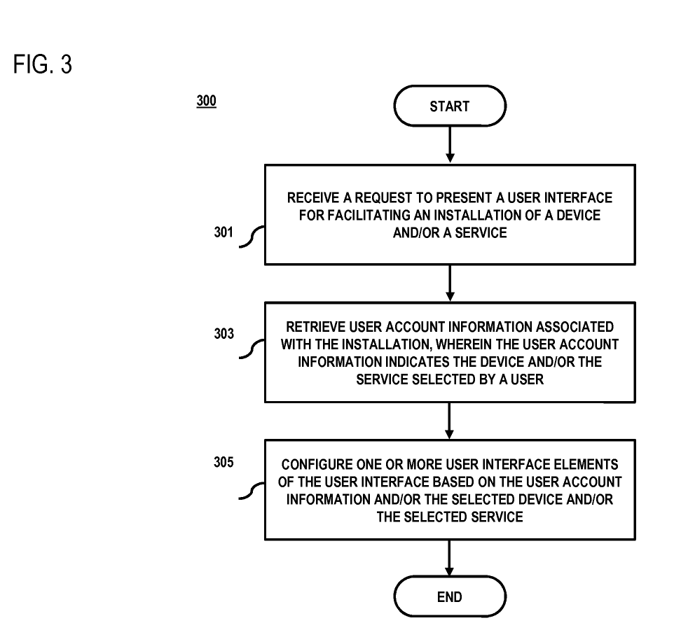

FIG. 3 is a flowchart of a process for configuring one or more user interface elements for facilitating an installation of a device, a service, according to one embodiment.

In step 301, the configuration platform 115 receives a request to present a user interface for facilitating an installation of a device, a service, or a combination thereof. In one embodiment, the device, the service, or a combination thereof is associated with a phone service, an internet service, a television service, a network service, or a combination thereof. In one scenario, a network service comprises of email services, media services, or a combination thereof.

In step 303, the configuration platform 115 retrieves user account information associated with the installation, wherein the user account information indicates the device, the service, or a combination thereof selected by a user.

In step 305, the configuration platform 115 configures one or more user interface elements of the user interface based on the user account information, the selected device, the selected service, or a combination thereof, wherein the one or more user interface elements include a header section, a progress navigation section, a content section, a footer section, or a combination thereof.

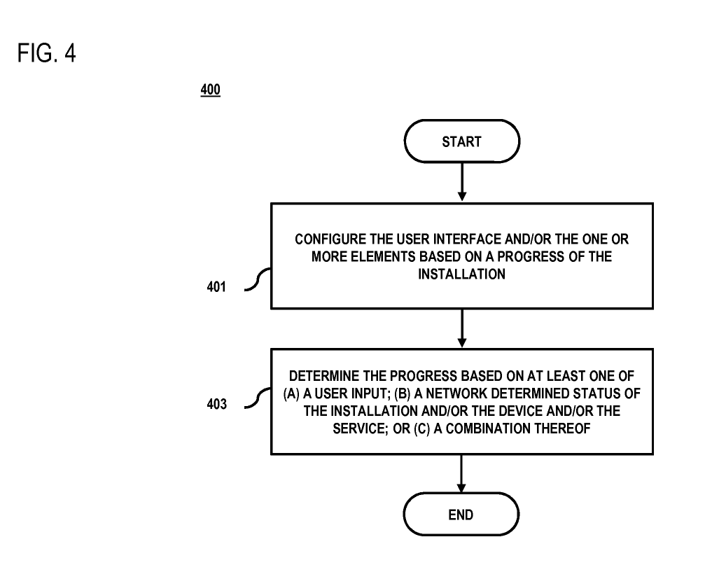

FIG. 4 is a flowchart of a process for configuring one or more user interfaces and/or user interface elements, according to one embodiment.

In step 401, the configuration platform 115 configures the user interface, the one or more elements, or a combination thereof based on a progress of the installation. In one scenario, the configuration platform 115 causes a presentation of one or more display interface as a visual guidance information to a user on device connection, user interaction, device activation, or a combination thereof. In another scenario, the configuration platform 115 causes a presentation of a catalog interface that allows a user to select options for registration and installation a device.

In step 403, the configuration platform 115 determines the progress based on at least one of (a) a user input; (b) a network determined status of the installation, the device, the service, or a combination thereof; or (c) a combination thereof. In one example embodiment, the configuration platform 1115 may cause a visual display of a progress indicator which changes dynamically from 0% to 100%, wherein the progress indicator reaches 100% upon completion of device activation.

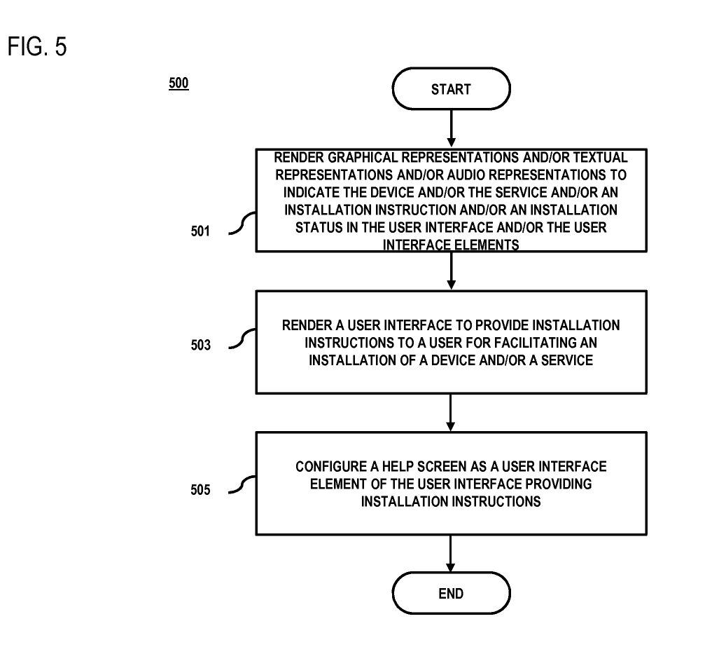

FIG. 5 is a flowchart of a process for rendering several representations in the user interface for providing information to a user, according to one embodiment.

In step 501, the configuration platform 115 renders one or more graphical representations, one or more textual representations, one or more audio representations, or a combination to indicate the device, the service, an installation instruction, an installation status, or a combination in the user interface, the one or more user interface elements, or a combination thereof. In one scenario, the configuration platform 115 may provide textual representation to a user on installation instruction and/or installation status, for example, success messages, failure messages, activation steps, setup instructions, etc. In another scenario, the configuration platform 115 may provide visual representation of steps for installing a device, for example, image of the device, image of the component, etc. In a further scenario, the configuration platform 115 may provide aural instructions to a user on the installation status, installation steps etc.

In step 503, the configuration platform 115 renders a user interface to provide installation instructions to a user for facilitating an installation of a device, a service, or a combination thereof. In one scenario, the configuration platform 115 renders user interface elements to assist a user in setting up a router and activating a secured network. In another scenario, the configuration platform 115 may present user interface elements to connect and activate an equipment. In one example embodiment, a user may be presented with user interface elements instructing him how to proceed with installation of a device, for example, a user may be instructed on cable selection, outlet selection, buttons selection, etc.

In step 505, the configuration platform 115 configures a help screen as a user interface element of the user interface providing installation instructions, wherein the help screen includes an instant messaging chat session. In one scenario, the configuration platform 115 may configure an instant messaging chat session to assist a user with registration and installation of a device. In one example embodiment, if a user is unable to activate his device, then the user can have a live chat session with an agent for troubleshooting purposes.

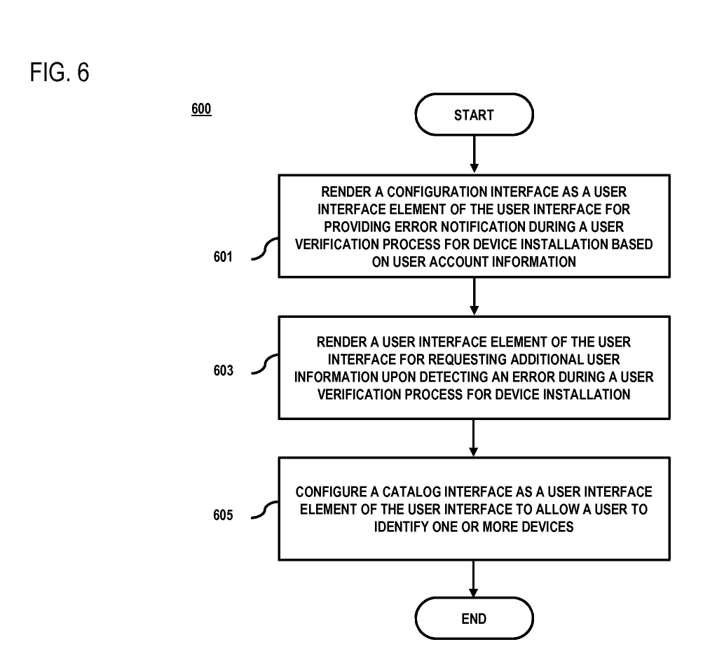

FIG. 6 is a flowchart of a process for rendering a user interface element of the user interface for providing one or more notification during a user verification process, according to one embodiment.

In step 601, the configuration platform 115 renders a user interface element of the user interface for providing error notification during a user verification process for device installation based on user account information, wherein user account information include a preset username and password combination, a pin code, one or more identifiers, other authentication mechanisms, or a combination thereof. In one scenario, the configuration platform 115 causes a verification of user information to configure at least one device to a secured network. The configuration platform 115 detects an error during a user verification process based, at least in part, on predefined values. In one scenario, the configuration platform 115 may verify personal information of a user, for example, a username and a password combination. If the username and the password do not match, the configuration platform 115 may display an error message to the user informing him that the data entered is incorrect.

In step 603, the configuration platform 115 renders a user interface element of the user interface for requesting additional user information upon detecting an error during a user verification process for device installation. In one scenario, the configuration platform 115 causes a presentation of a user interface element representing an activation failure notification. Then, the configuration platform 115 causes a presentation of a user interface element requesting additional user information for registration and installation of at least one device. In one example embodiment, the configuration platform 115 may give a second chance to a user upon detecting that the information entered by the user is incorrect. The configuration platform 115 may present a user interface element asking the user to enter other information, for example, order number of the device and the zip code information. Then, the configuration platform 115 may navigate the user to the registration page upon verification of the other information.

In step 605, the configuration platform 115 configures a catalog interface as a user interface element of the user interface to allow a user to identify one or more devices, wherein a catalog interface includes device images, device names, device model numbers, device serial numbers, or a combination thereof. In one scenario, the configuration platform 115 causes a presentation of a user interface element displaying the details of a device, for example, the configuration platform 115 may display an image of a digital adapter, the configuration platform 115 may also display model number and serial number of the digital adapter, the configuration platform 115 may further display a help icon to a user for locating the model number and the serial number for the digital adapter.

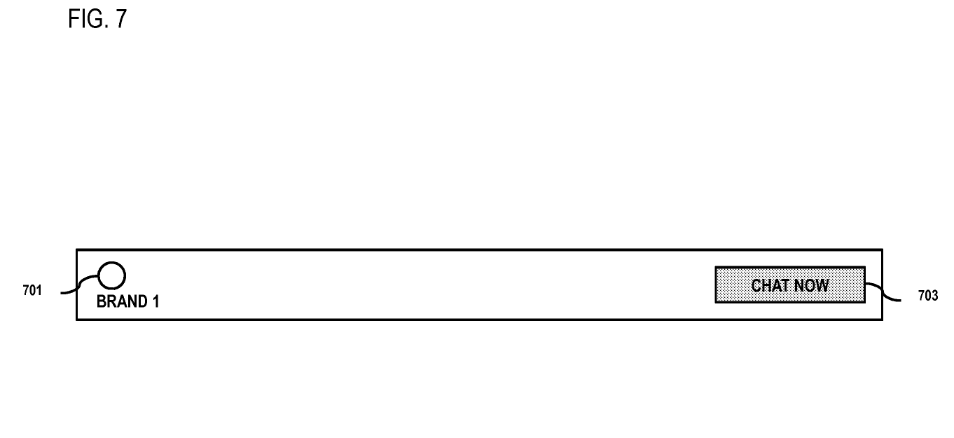

In one embodiment, an interactive web based application that allows a user to register and install their device may comprise of four components, namely (a) header section; (b) progress navigation section; (c) content section; (d) footer section. FIG. 7 is a user interface diagram that represents a header section, according to one example embodiment. In one embodiment, the header section is a placeholder for brand information[701], and may include one or more support elements that may be helpful for a user during the registration process [703]. In one example embodiment, a live chat support [703] may be provided to the at least one user for registering and installing the device.

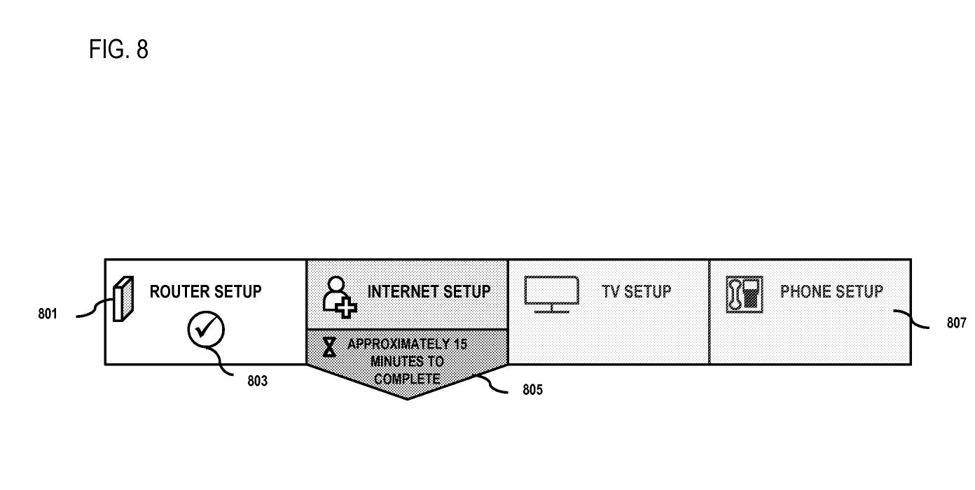

FIG. 8 is a user interface diagram that represents a progress navigation section, according to one example embodiment. In one embodiment, the progress navigation section is a guided visual navigation pattern which clearly indicates the number of modules involved in the process. The one or more modules may vary based on the platform and the device purchased by a user. In one scenario, the maximum number of modules may be five, and the minimum number of modules may be two which can be scaled further. Each module are visually represented in a progress navigation section, for example, an iconic representation of each modules with verbiage [801], a visual indication of completed module [803], a visual indication of ongoing module with average time it will take to complete that particular module [805], a visual indication of upcoming module [807]. The progress navigation section communicates with a user with the referred visual elements [801, 803, 805, 807]. The header and progress navigation sections are carried forward in all modules.

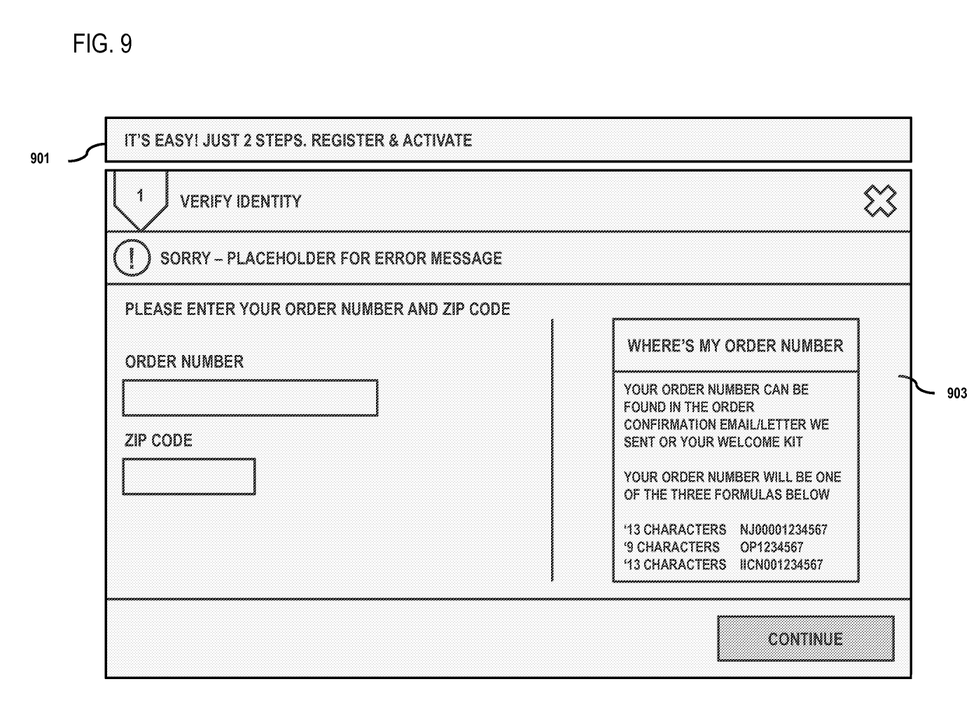

FIG. 9 is a user interface diagram that represents a content section layout pattern, according to one example embodiment. In one embodiment, the content section layout pattern may be divided in two patterns: (a) a static content header or interactive content with visual indication of user selected options [901], and (b) a user interactive content area [903]. In one scenario, the content section and the footer section varies as per modules.

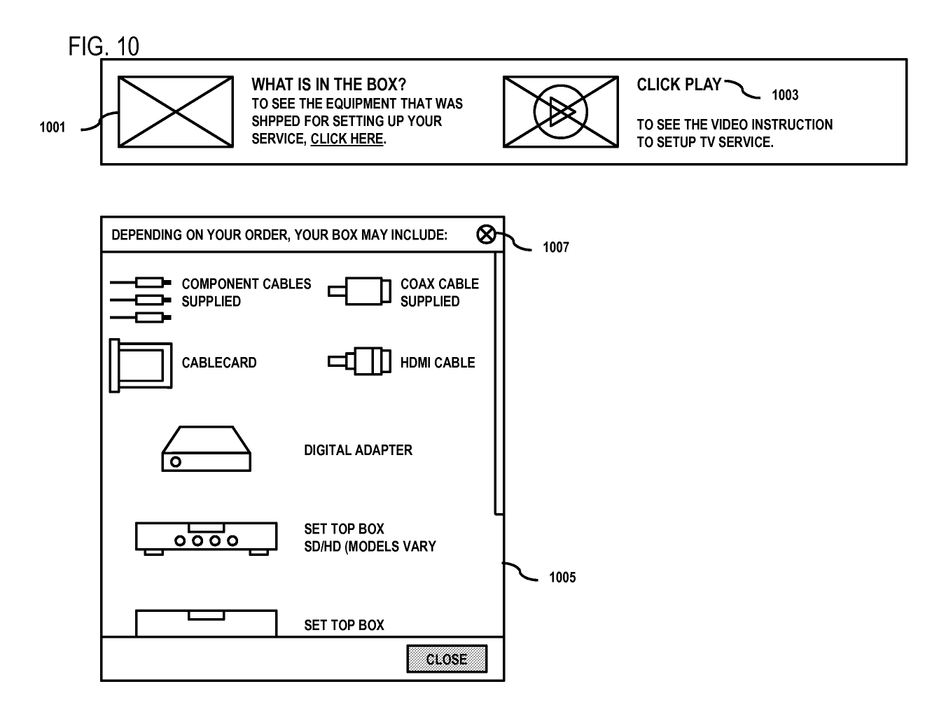

FIG. 10 is a user interface diagram that represents a layout pattern for a footer section, according to one example embodiment. In one embodiment, the footer section layout pattern is a placeholder for displaying help content related to a particular module for end user, for example, device related information [1001], or videos [1003] etc. Such footer section is optional and may or may not appear in each module. In another embodiment, once a user touches any item of the footer content, relevant information may be displayed as overlay content [1005] in the same screen, the user may close the overlay content by clicking on the icon [1007].

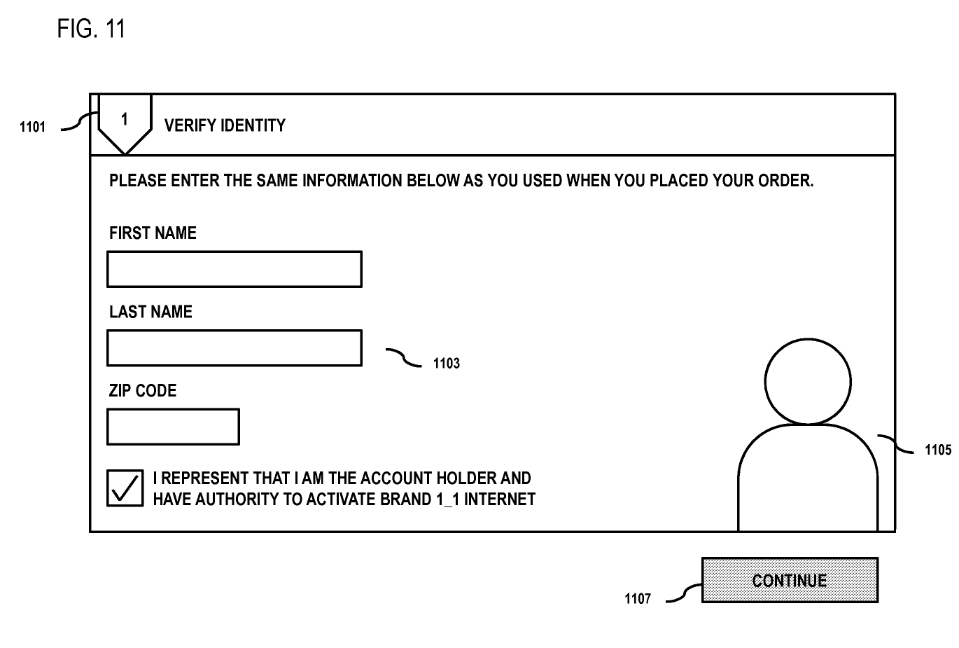

In one scenario, the network setup may be the first step once the at least one user finishes the router set up for registering and installing a device. The network setup process may involve user verification, wherein the at least one user may be asked to register and create an account to configure a device. In one scenario, if a user is subscribed for an internet plan, the activation of an internet plan may take place upon completion of account registration. In one embodiment, the network setup layout may be divided into two steps: (a) end user verification, and (b) register/activate accounts and network. FIG. 11 is a user interface diagram that represents an end user verification process by using a user's personal details and zip code information, according to one example embodiment. In one scenario, the end user verification process may comprise of a visual indicators of steps and messaging [1101], a user interaction form fields [1103], visual enhancement elements [1105], call to action/navigation [1107].

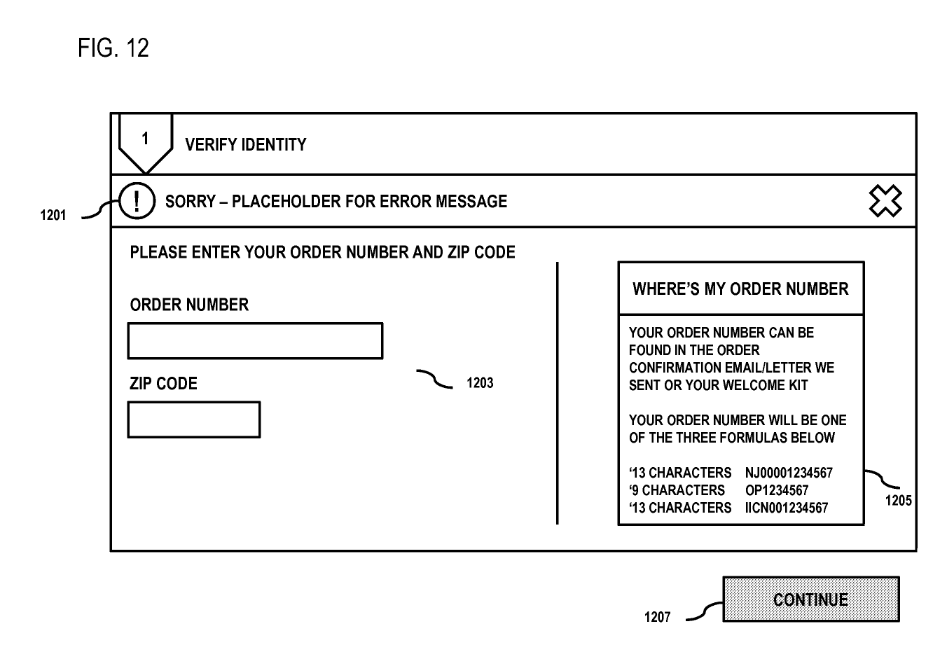

FIG. 12 is a user interface diagram that represents an end user verification process by using the order number, the zip code, according to one example embodiment. This is a resulting verification mechanism undertaken when the primary verification process is unsuccessful. In one embodiment, the second option layout for a verification process may comprise of error messaging place holder [1201], user interaction form fields [1203], information on where a user can find the order number [1205], call to action/navigation [1207]. In one scenario, the second option layout for a verification process may be presented with an appropriate failure message.

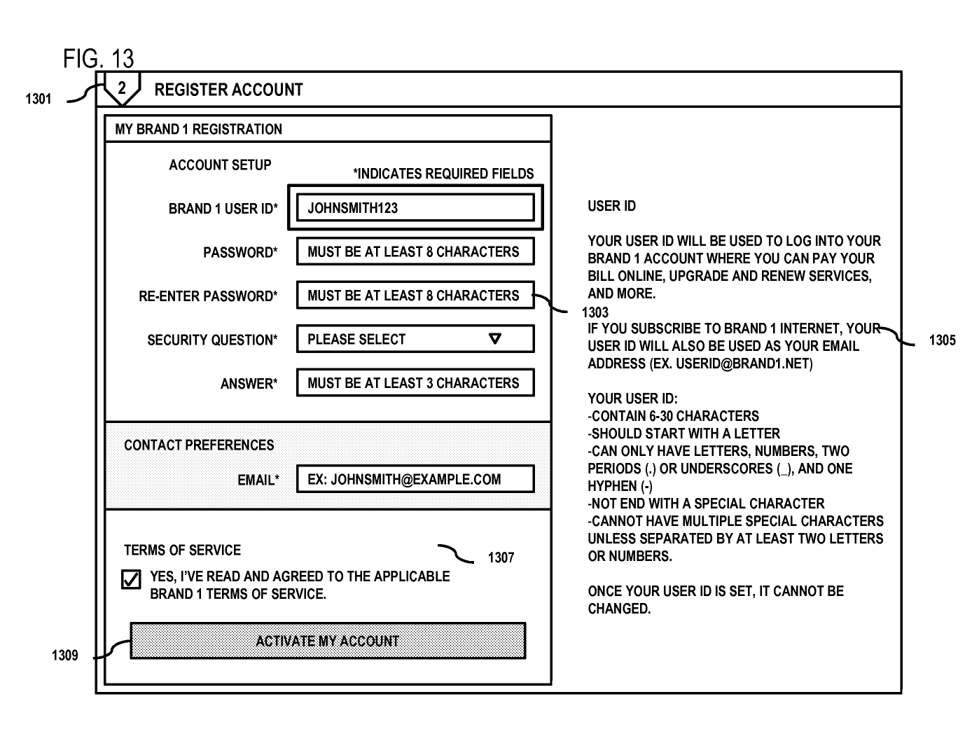

FIG. 13 is a user interface diagram that represents a navigation layout, according to one example embodiment. Once the verification process is completed, the user may be navigated to the registration layout with several user interaction and navigation patterns, for example, a visual indicators of steps and messaging [1301], a user interaction form fields for setting up the account with the service provider [1303], a help content related to individual form fields [1305], a view and accept terms of agreement for a service [1307], and a call to action/navigation [1309]. In one example embodiment, once the user enters the required information and hits the call to action, an activation Layout may be displayed.

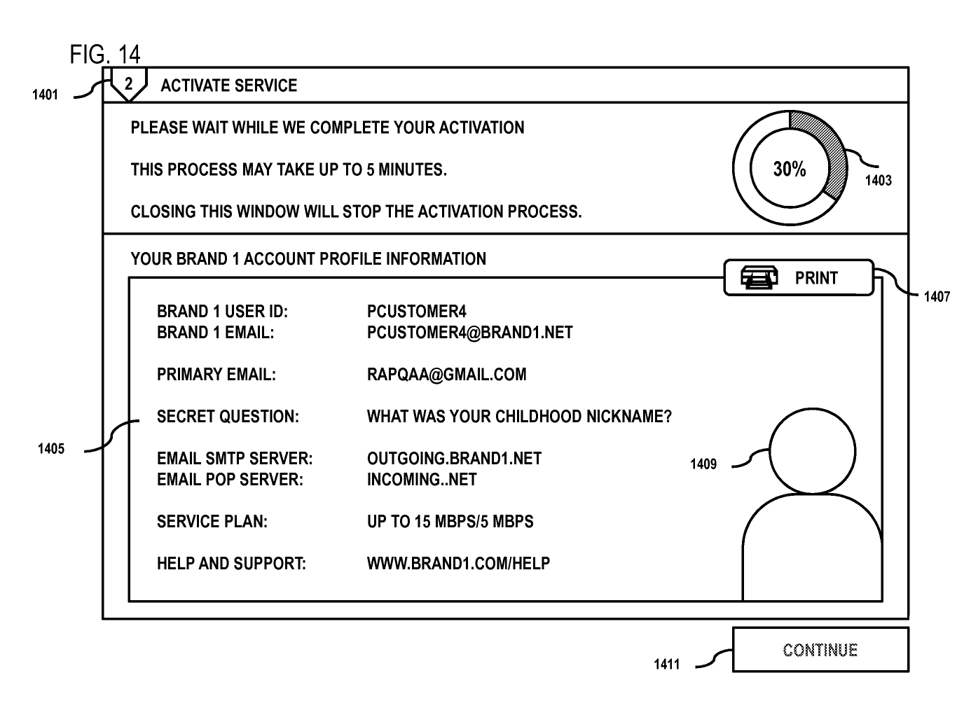

FIG. 14 is a user interface diagram that represents an activation layout, according to one example embodiment. In one scenario, an activation layout comprises of visual indication of process and navigation elements, for example, a visual indicators of steps and messaging [1401], a visual progress indicator which is dynamic and displays the percentage completed [1403], a user entered registration information[1405], a visual enhancement elements in right bottom [1407], a call to action which will invoke print action of user entered registration information [1409], a call to action/navigation only enables when progress indicator reaches 100% [1411].

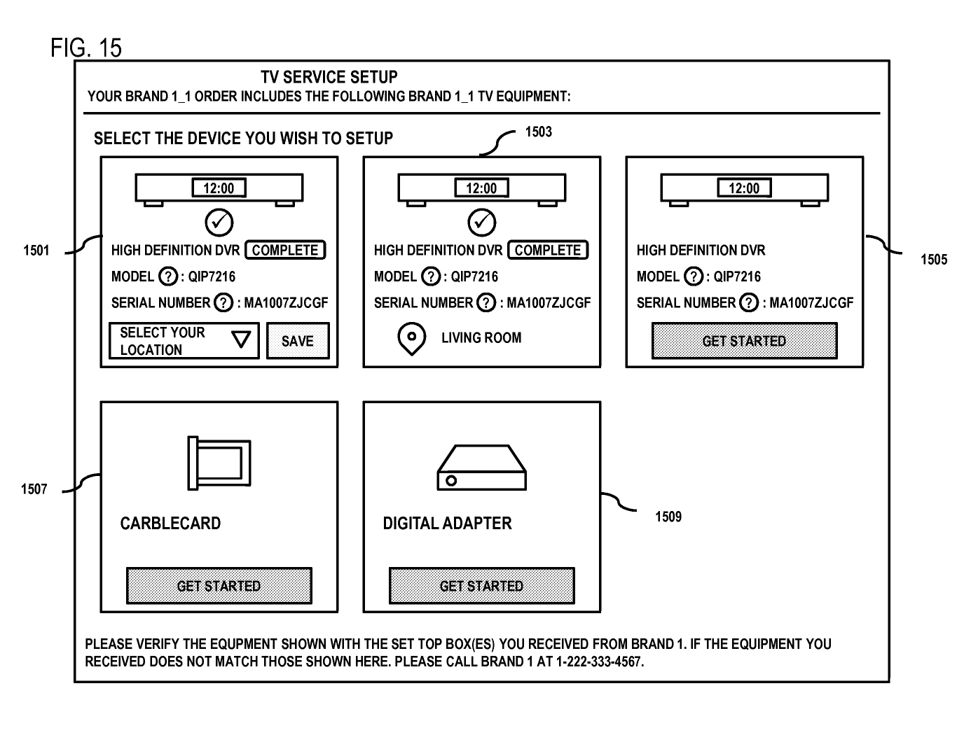

FIG. 15 is a user interface diagram that represents a television setup layout with graphical representation of different devices the customers have ordered, according to one example embodiment. A television setup is a multi-step process, it involves user interaction as well as back and forth navigation. In one scenario, a service provider may offer different type of devices like Digital Video Recorders [1501, 1503], Set Top Boxes [1505], Cable Cards [1507] and Digital Adapters [1509]. In one embodiment, the steps involved in the connectivity patterns, and the activation of each device may vary. In addition, the layout, the navigation and the user interaction may differ from each other.

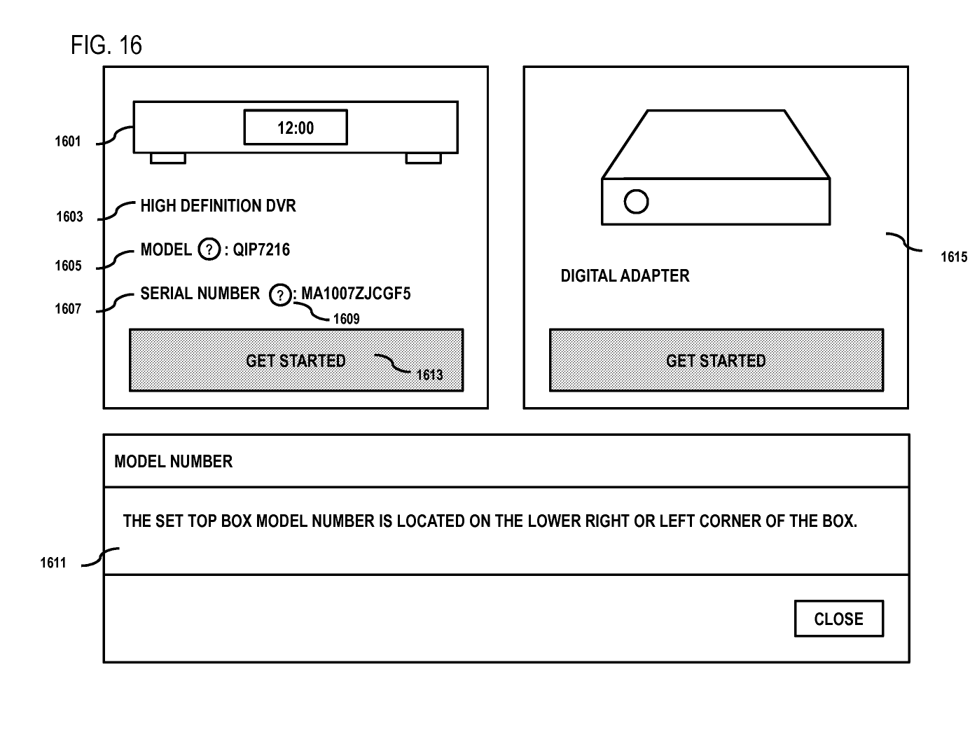

FIG. 16 is a user interface diagram that represents a details layout for a device, according to one example embodiment. In one scenario, a details layout for a device comprises of visual elements that communicates clearly to the user on identifying a device he has purchased. The details layout for a device comprises of several components, for example, a graphic image of the device [1601], the name of the device [1603], the model number of the device [1605], the serial number of the device [1607], a call to action help icon [1609] which will invoke the overlay [1611] which will have the verbiage about where to locate model and serial number in a particular device, a call to action/navigation [1615] to start the connection and activation process.

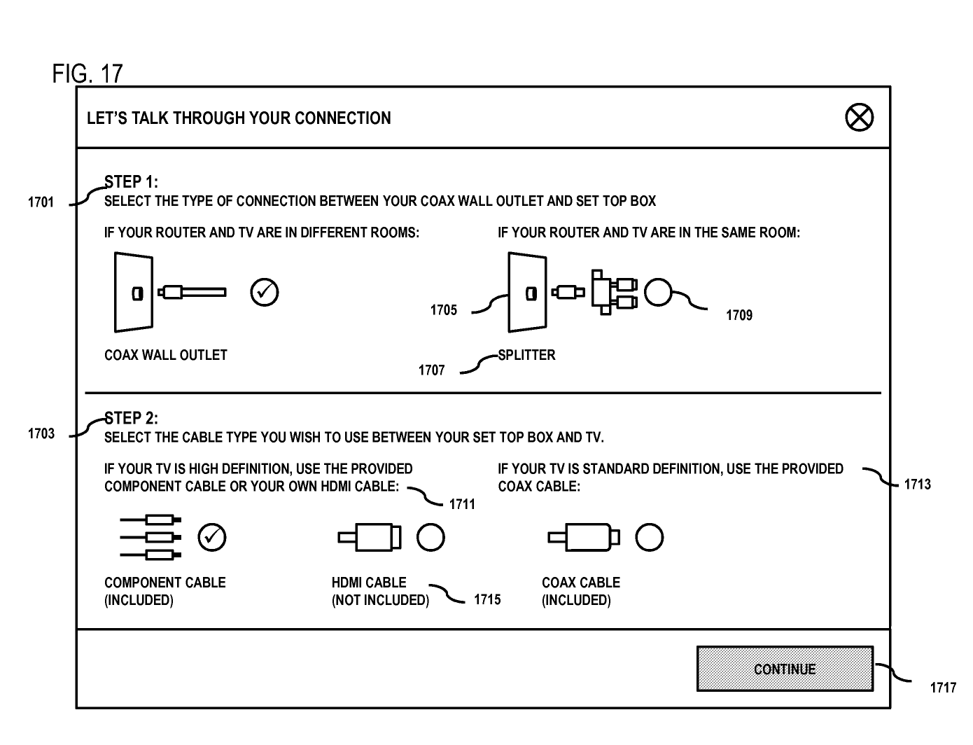

FIG. 17 is a user interface diagram that represents an overlay of the equipment component selection, according to one example embodiment. In one scenario, an equipment connection involves connecting the equipment with a wall outlet and a television, such connections can be performed with different type of cables. In one scenario, the option to choose the right combination is visually displayed during the equipment connection walkthrough, wherein the equipment component selection is split in two steps:
1. Wall outlet connection selection [1701];
2. Television cable type selection [1703].

In another scenario, the equipment component selection will have the following layout and user interaction elements:
1. Graphic/image of the component [1705];
2. Name of the component type [1707];
3. Radio buttons for selecting one component type in each step [1709].

In a further scenario, the component selection is further simplified by splitting the type of component cable that can be used with two types of televisions:
1. Standard definition televisions [1711];
2. High definition televisions [1713].

In addition, there may be an indication of whether the particular component cable is included with the default shipment or not, for easy understanding [1715]. After making the selections, the user may proceed by clicking/touching the ‘Continue’ icon [1717] to navigate towards the detail connection and activation screen.

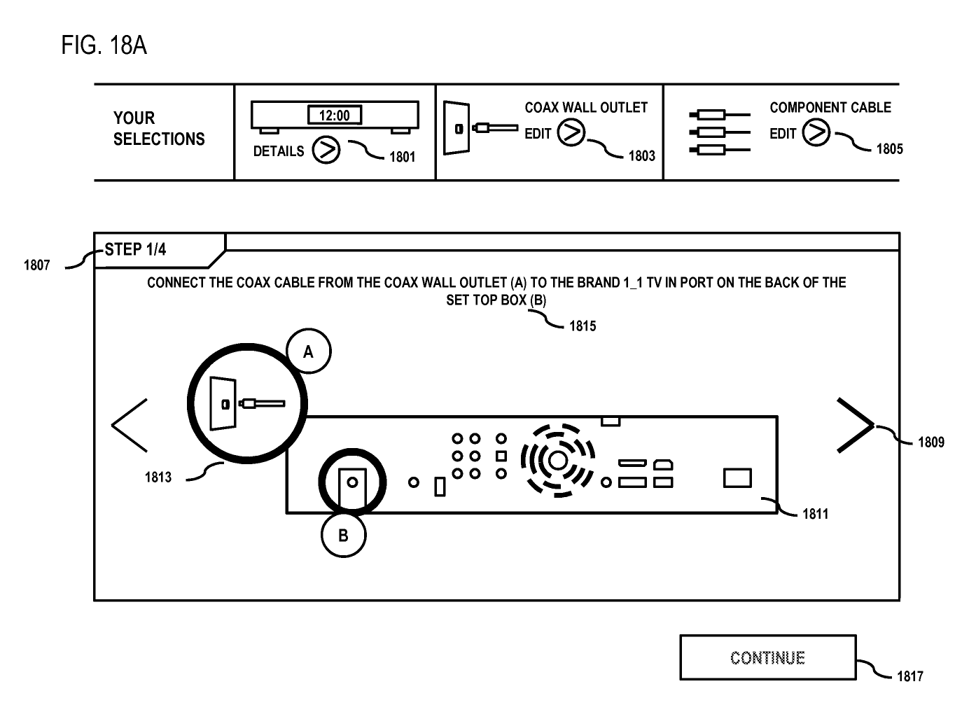

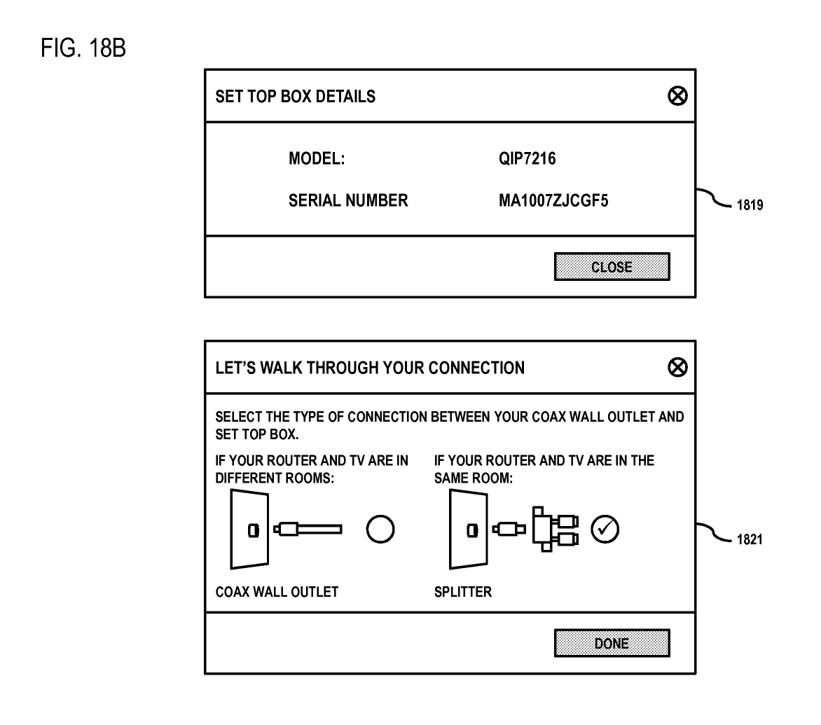

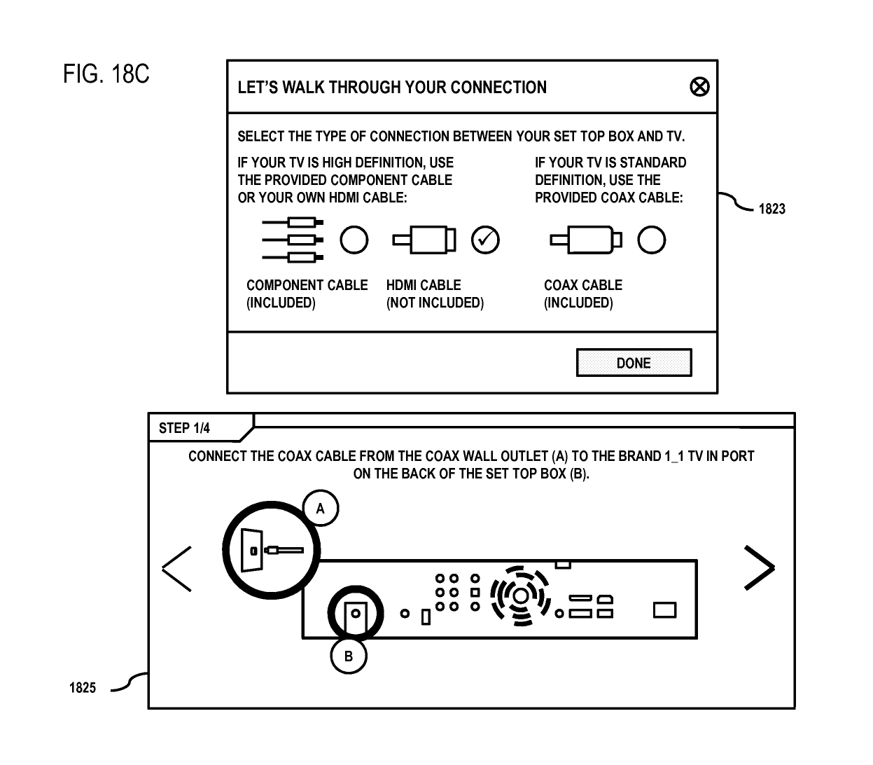

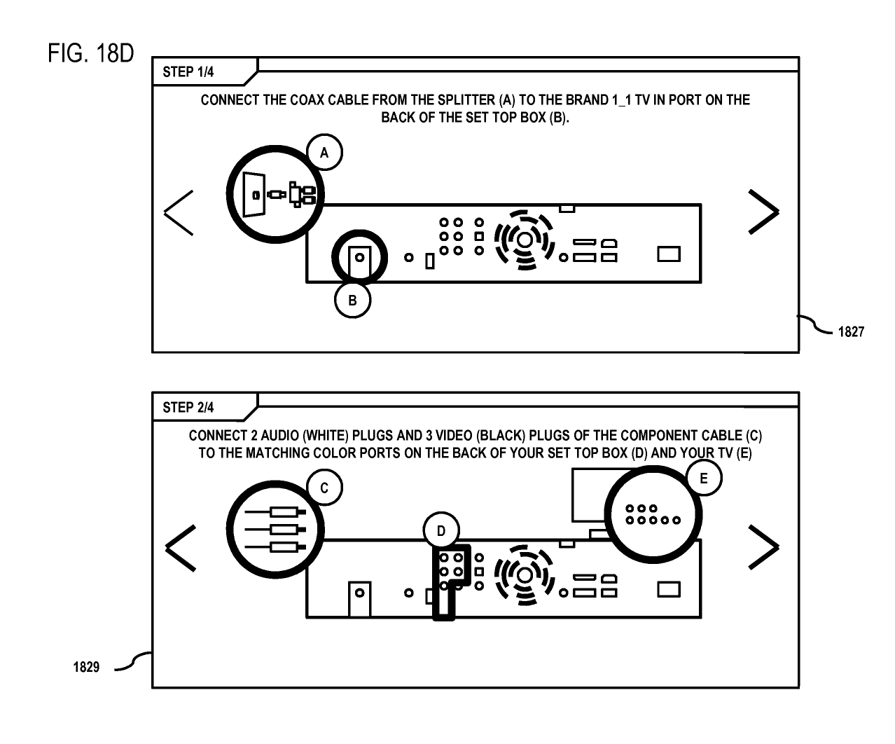

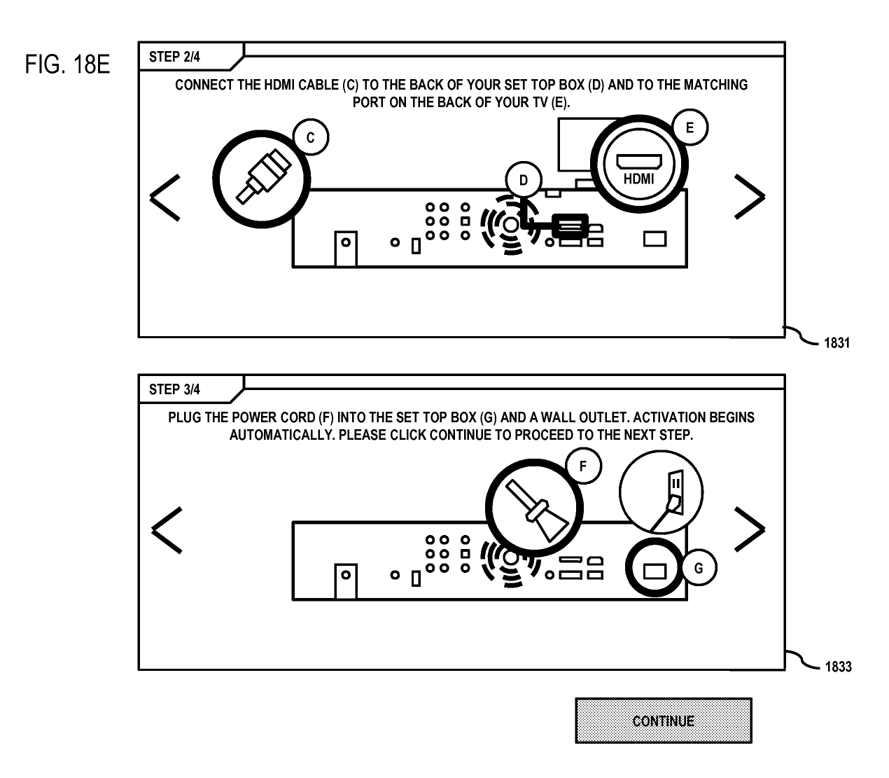

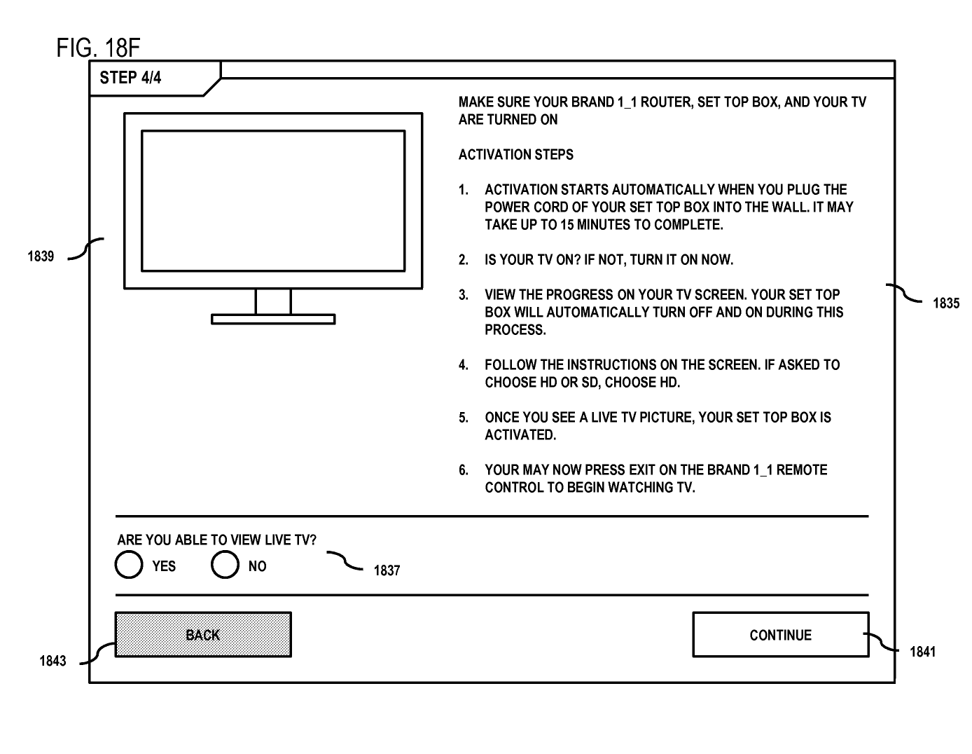

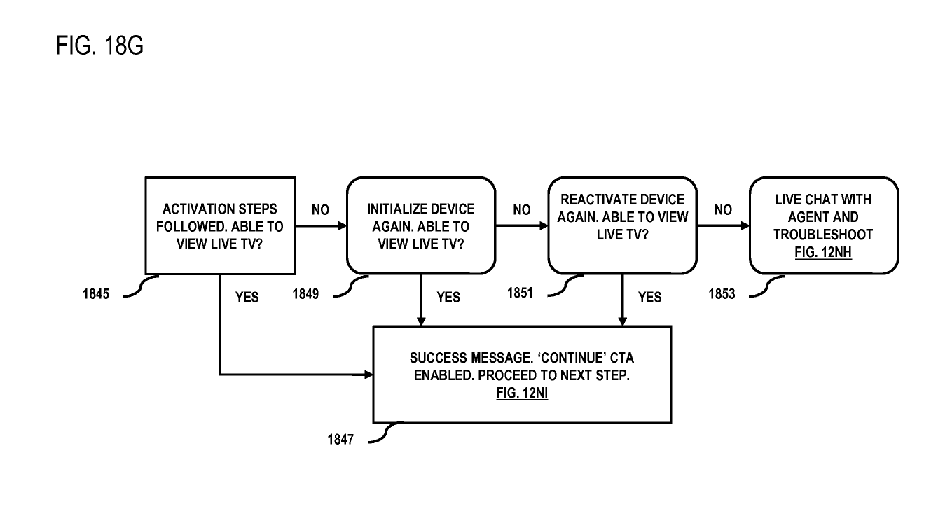

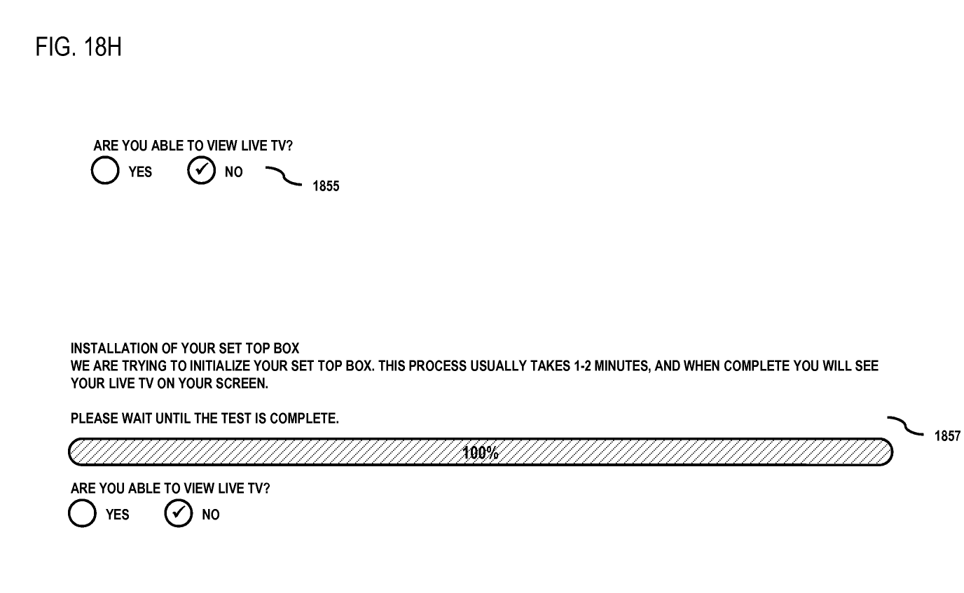

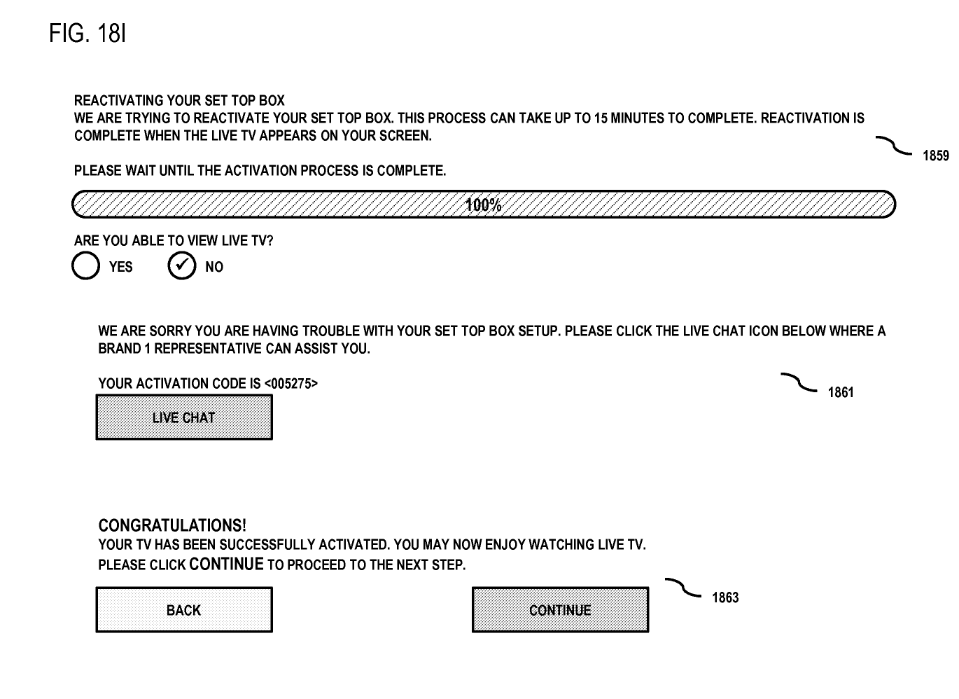

FIGS. 18A-18F are user interface diagrams that represent an equipment connection and activation layout, according to one example embodiment. In one scenario, the equipment connection and activation layout is divided into two blocks, and both the blocks will have interactive content. The top block may have the user selection information and lower block may have detail graphical connection walkthrough area. In one embodiment, the top block layout may show what the user has selected from the previous screen:
1. Selected device with CTA to view details [1801];
2. Selected wall outlet type with CTA to change the selection type [1803];
3. Selected component cable type with CTA to change the selection type [1805].

In one scenario, the graphical connection walkthrough area may have step by step connection walkthrough with detail graphical diagrams of the connection process associated with detail verbiage:
1. No of steps the user need to navigate in connection and activation process [1807];
2. Next and Previous step navigational CTA's which helps user to go through each steps in detail [1809];
3. Graphical diagram of connection [1811];
4. Connection start and end point visually marked, labeled and focused in graphical diagram for easy understanding for end user [1813];
5. Verbiage that communicates with visually marked elements in graphical diagram [1815];
6. Navigational CTA which will get enabled only when user reaches a step before the last step, activation process [1817]

In one embodiment, when a user clicks/touches ‘Details’ CTA [1801] for the selected devices, it launches the details overlay [1819]. In another embodiment, when a user clicks/touches the ‘Edit’ CTA in the selected wall outlet [1803] and the component cable type [1805], an overlay may be launched wherein the user may directly change the component type [1821, 1823]. This process may help the user to change his selections without navigating back and reselecting. In one scenario, after changing the selection, a user may submit with ‘Done’ CTA [1821], wherein the graphical connection walkthrough area may change according to the user selection. In one scenario, when a user changes the wall outlet from coax to splitter and clicks/touches ‘Done’ CTA, the graphical connection walkthrough also changes [1825, 1827]. In another scenario, when a user changes the television component cable and submits with ‘Done’ CTA [1823], the graphical connection walkthrough area may change according to user selection [1829, 1831]. In a further scenario, the last step in the navigation is the activation process which may have a troubleshooting user interaction pattern. The ‘Continue’ CTA may be enabled for the user when he is a step before in graphical connection walkthrough section [1833].

In one embodiment, when a user clicks or touches the ‘Continue’ CTA, the user may be navigated to a final activation section [FIG. 18F] containing elements, for example, a list of instructions for Activation steps [1835], a troubleshooting user interactive section [1837], a graphical view of what a user sees in television during the activation process [1839], a ‘Continue’ CTA which may be enabled once the user confirms successful activation by selecting ‘Yes’ Radio button in troubleshooting questionnaire [1841], a ‘Back’ CTA to revisit connection walkthrough section, if required [1843].

FIG. 18G represents a flow diagram for television equipment activation, troubleshooting navigation and user interaction, according to one example embodiment. In one scenario, the activation steps involves the configuration platform 115 asking the users whether they are able to view live television [1845], if yes, the configuration platform 115 may display a success message [1847]. In another scenario, the configuration platform 115 may initialize the device again upon determination that the user has not been able to view the live television [1849]. Subsequently, the user is queried whether he/she is able to view the live television [1849], if yes, the success message is displayed [1847]. In a further scenario, the configuration platform 115 may reactivate the device after step 1849 upon determination that the user cannot see live television [1851]. Upon reactivation the configuration platform 115 may query the user whether he/she are able to view live television [1851], if yes, the success message is displayed [1847]. In another scenario, the configuration platform 115 may activate a live chat with an agent upon determination that the user cannot view live television despite several reactivation of the device [1853].

FIGS. 18H and 18I are diagrams that represents the flow diagrams for television equipment activation, troubleshooting navigation and user interaction, according to one example embodiment. In one scenario, FIG. 1855 is a pictorial representation of flow diagram 1845. In another scenario, FIG. 1857 is a pictorial representation of flow diagram 1849. In a further scenario, FIG. 1859 is a pictorial representation of flow diagram 1851. In another scenario, FIG. 1861 is a pictorial representation of flow diagram 1853. In another scenario, FIG. 1863 is a pictorial representation of flow diagram 1847.

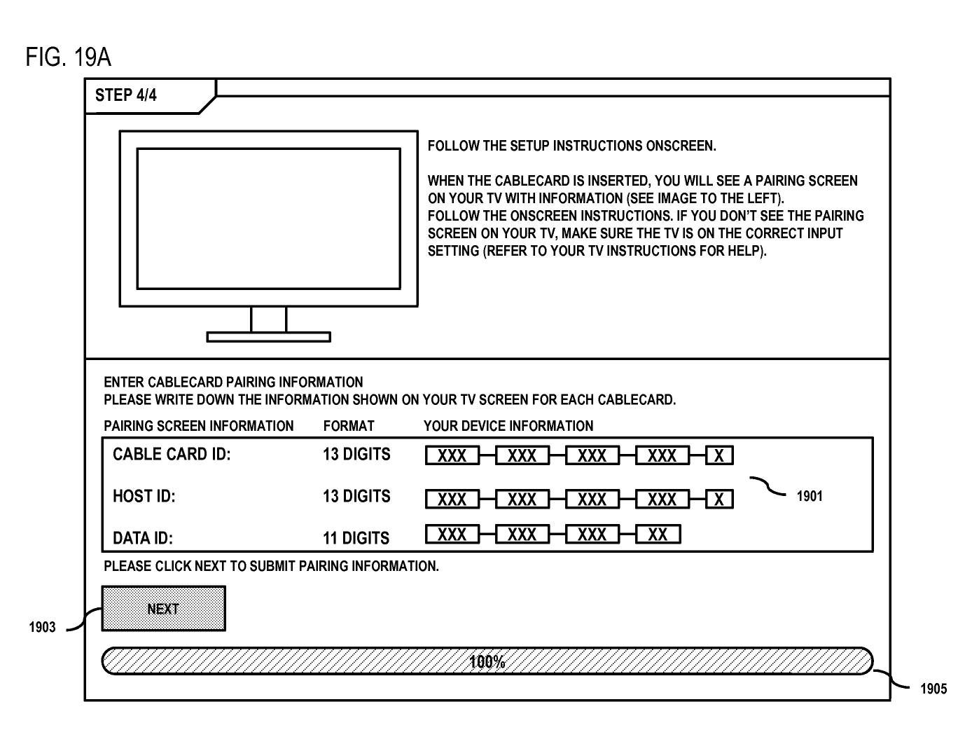

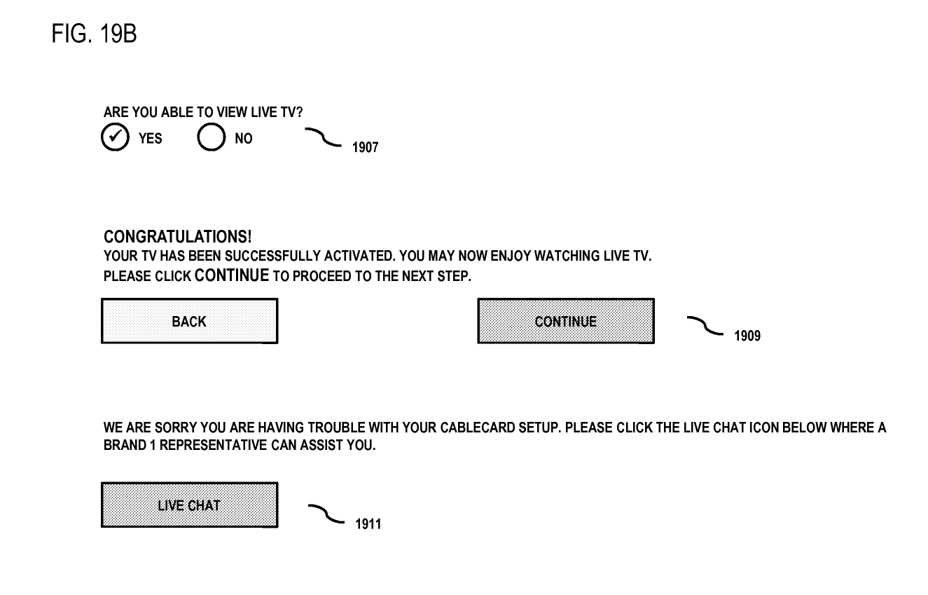

FIGS. 19A and 19B are user interface diagrams that represents different layout for user interaction during an activation process for cable card devices, according to one example embodiment. In one scenario, the user needs to enter the information displayed in the television in order to pair the device. The activation process starts when the user enters all the required inputs [1901] and clicks/touches the ‘Next’ CTA [1903]. The progress of activation will be shown visually as progress indicator which changes dynamically from 0% to 100% live below the CTA [1905]. In another scenario, once the progress indicator reaches 100% and activation is completed, a user may be presented with interactive questionnaire [1907]. In a further scenario, upon activation success and the user selecting ‘Yes’ radio option, a success message may be shown and ‘Continue’ CTA may be enabled [1909]. In another scenario, upon determination of an activation failure, and the user selecting the ‘No” radio option, a ‘Live chat’ CTA for communicating with agent for troubleshooting may be presented to the users [1911].

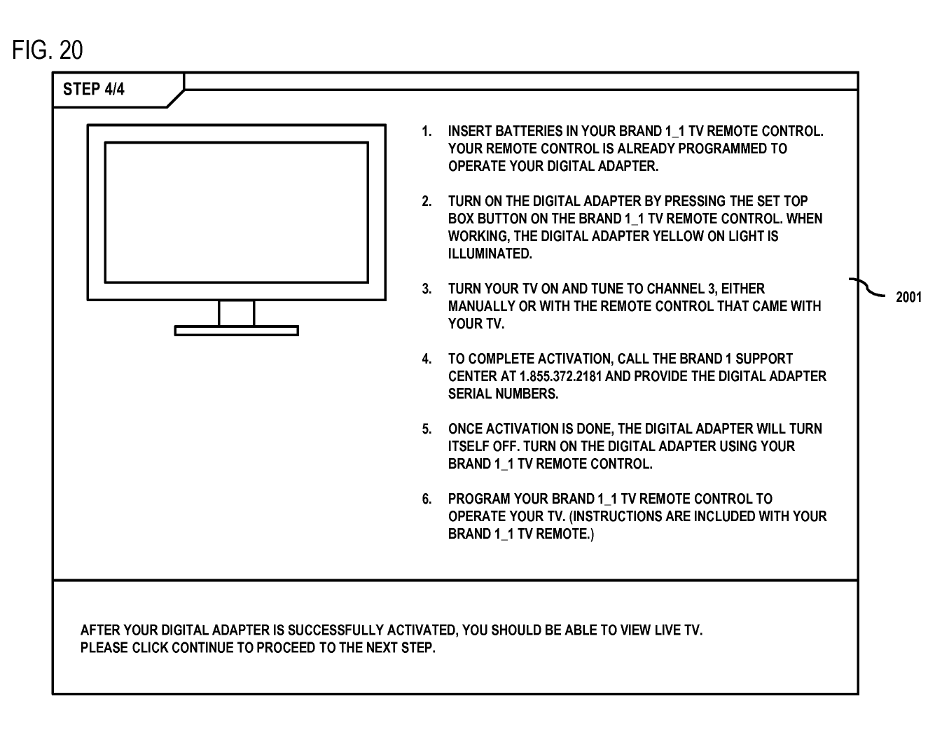

FIG. 20 is a user interface diagram that represents an activation process for a digital adapter, according to one example embodiment. In one scenario, the activation process for a digital adapter may not have any user interaction [2001]. The activation is done by the support center and the user need to call the support center for initiating the activation process. In another scenario, screen instructions and relevant messaging may be shown in the layout, including the telephone number for the support center.

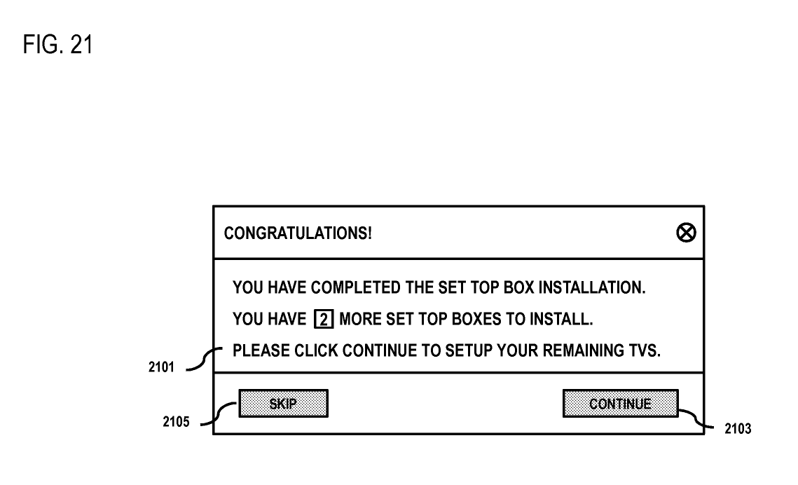

FIG. 21 is a user interface diagram that represents a success overlay which is presented after the user clicks/touches ‘Continue’ CTA, according to one example embodiment. In one scenario, the success overlay may comprise of the following elements:
1. Pending devices that needs to be activated [2101];
2. ‘Continue’ CTA to proceed to activate pending devices [2103];
3. ‘Skip’ CTA to skip and move to next module [2105]. A user may activate pending devices in this section after completing all modules.

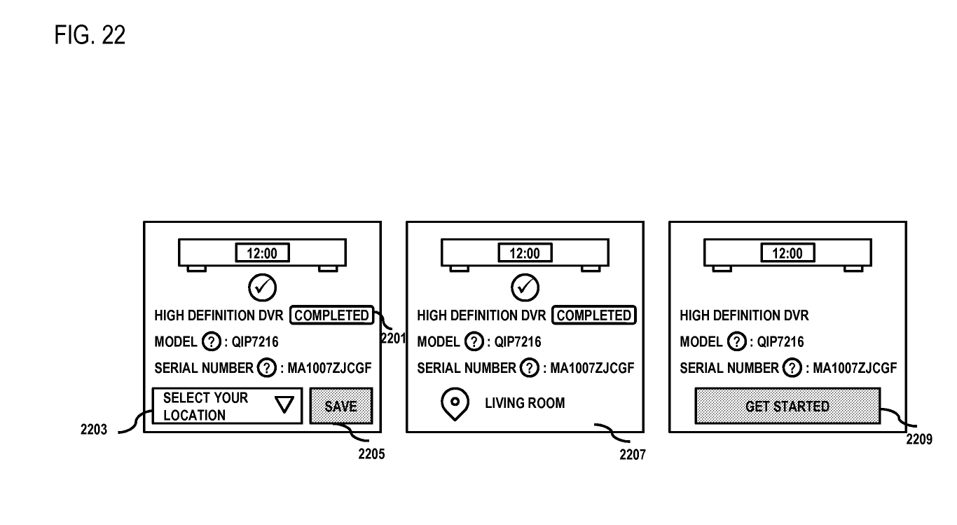

FIG. 22 is a user interface diagram that represents details of a device displayed with updates of activation, according to one example embodiment. In one scenario, when a user clicks/touches on the ‘Continue’ CTA, the user is taken back to television service setup start page [FIG. 15]. The television service setup start page is displayed with updates of activation, for example, visual elements showing that activation is completed [2201], an option to choose the location in house where the device is activated [2203], a ‘Save’ CTA to save the location [2205]. In another scenario, when a user clicks/touches ‘Save’ CTA, the location details may be saved and displayed in the layout [2207]. In a further scenario, a user can continue activation of other devices, whereas devices that are pending activation may have ‘Get Started’ CTA and the user can start by clicking/touching the ‘Get Started’ CTA [2209].

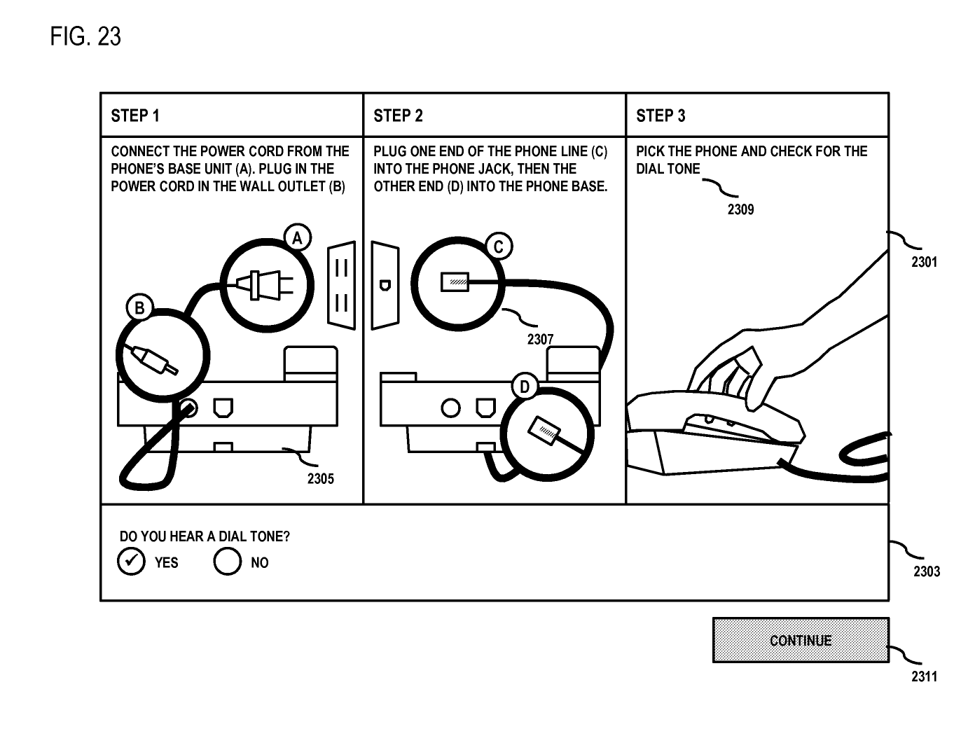

FIG. 23 is a user interface diagram that represents a layout for a phone setup, according to one example embodiment. In one scenario, the phone setup layout is divided into two sections, namely, (a) a connection walkthrough diagram section [2301], and (b) a troubleshooting section [2303]. In another scenario, the connection walkthrough diagram section [2301] is further presented in three steps which communicate with the user visually on connecting the phone with required components:
1. Graphical diagram of connection [2305];
2. Connection start and end point visually marked, labeled and focused in graphical diagram for easy understanding for end user [2307]; and
3. Verbiage that communicates with visually marked elements in graphical diagram [2309].
   On completion of the setup user can navigate to next module using the ‘Continue’ CTA [2311].

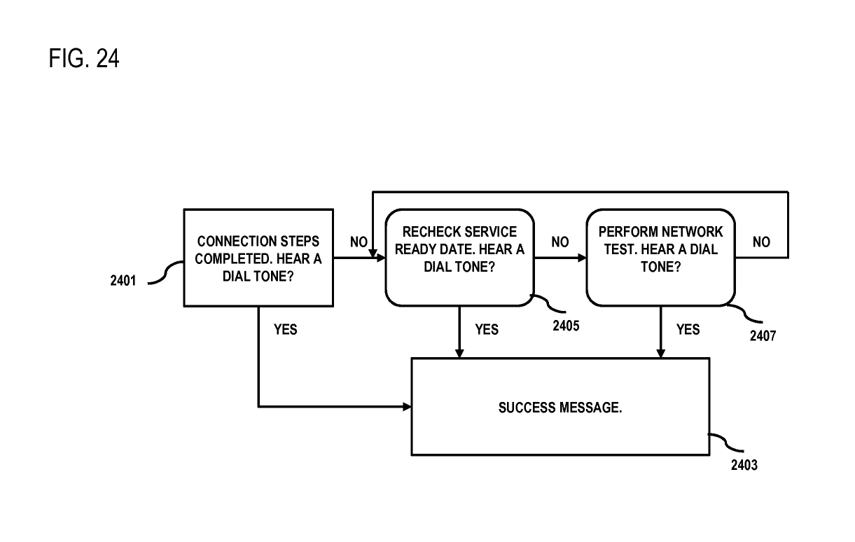

FIG. 24 is a flow diagram for phone activation, troubleshooting navigation and user interaction, according to one example embodiment. In one scenario, the configuration platform 115 may query a user whether he/she hears a dial tone [2401], if yes, the configuration platform 115 may display a success message [2403]. In another scenario, the configuration platform 115 may recheck that a service ready date has been reached upon a determination that a user cannot hear a dial tone. After rechecking the service ready date, the configuration platform 115 may query the user whether he/she hears a dial tone [2405]. In a further scenario, the configuration platform 115 may perform network test after rechecking the service ready date upon determination that a user cannot hear a dial tone [2407].

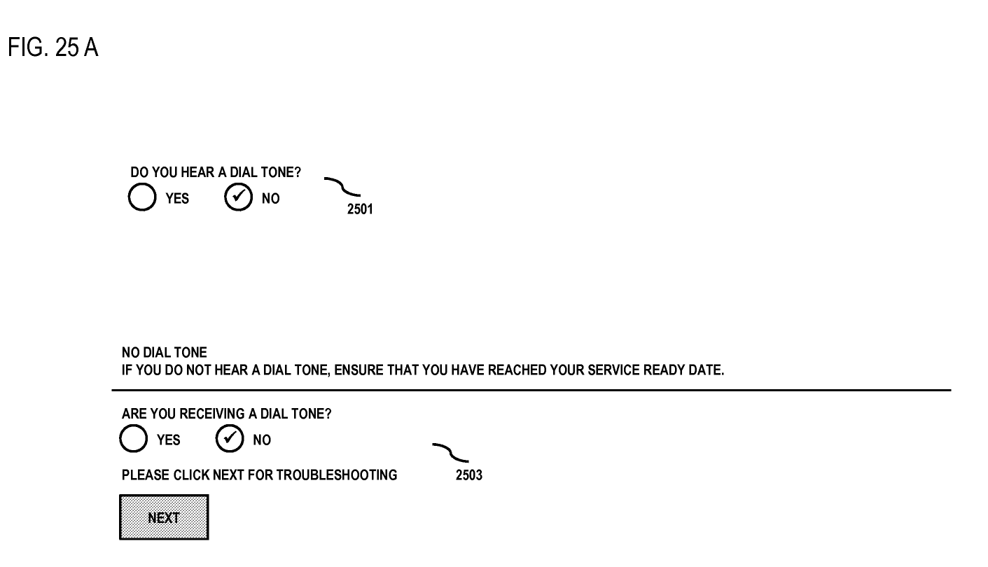

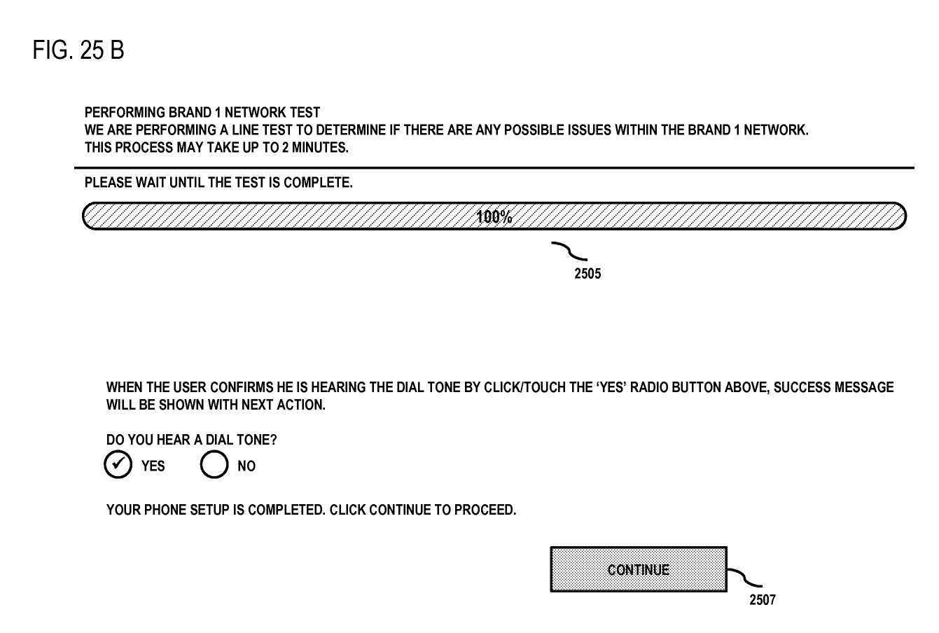

FIGS. 25A and 25B are user interface diagrams that represents the flow diagrams for phone activation, troubleshooting navigation and user interaction, according to one example embodiment. In one scenario, FIG. 2501 is a pictorial representation of flow diagram 2401. In another scenario, FIG. 2503 is a pictorial representation of flow diagram 2405. In a further scenario, FIG. 2505 is a pictorial representation of flow diagram 2407. In another scenario, FIG. 2507 is a pictorial representation of flow diagram 2403.

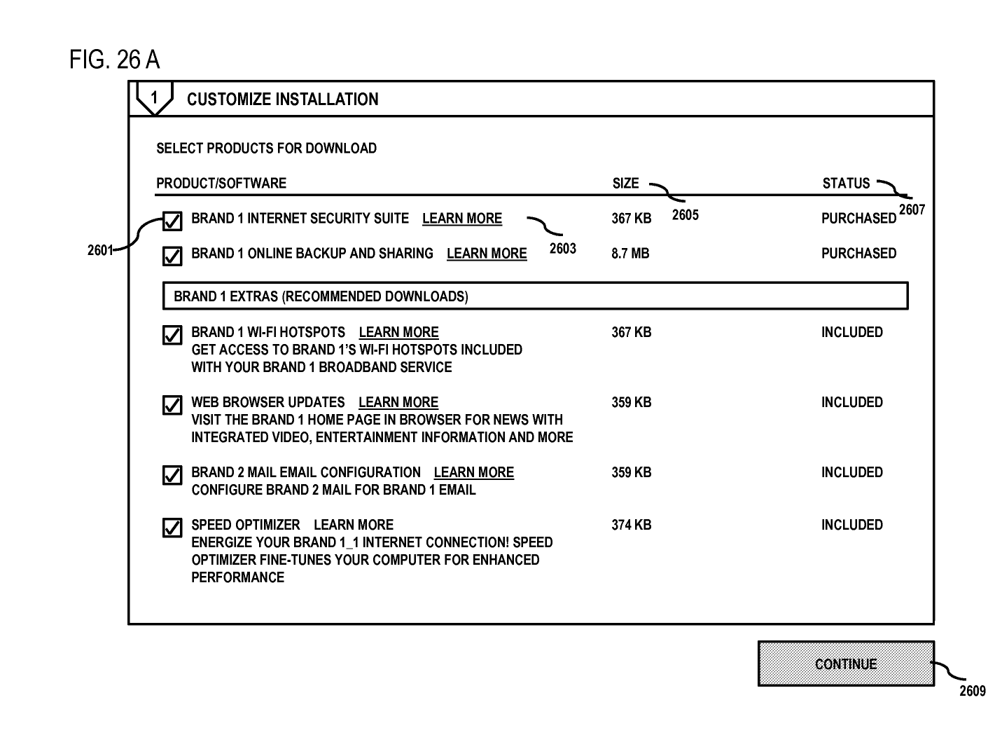

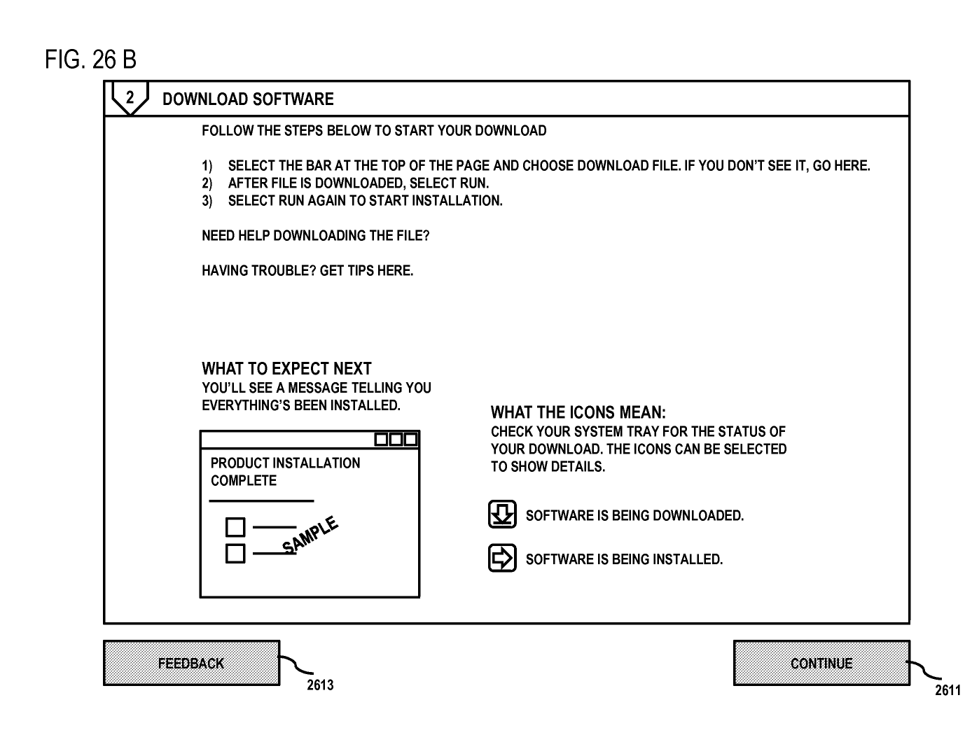

FIGS. 26A and 25B are user interface diagrams for software setup layout, according to one example embodiment. In one embodiment, FIG. 26A represents a customized selection of software. In another embodiment, FIG. 26B represents instructions regarding software download. In one scenario, the customized selection of software layout may have the software's listed in the grid structure with following details:
1. Checkboxes for user interaction [2601];
2. Software name with ‘Learn more’ text CTA which may give an insight to user about the product [2603];
3. Size of the software [2605];
4. Status which indicates whether the software is purchased by the user or it's an extra software recommended by the service provider which is free [2607]; and
5. ‘Continue’ CTA to navigate to step 2 download layout after selection [2609].

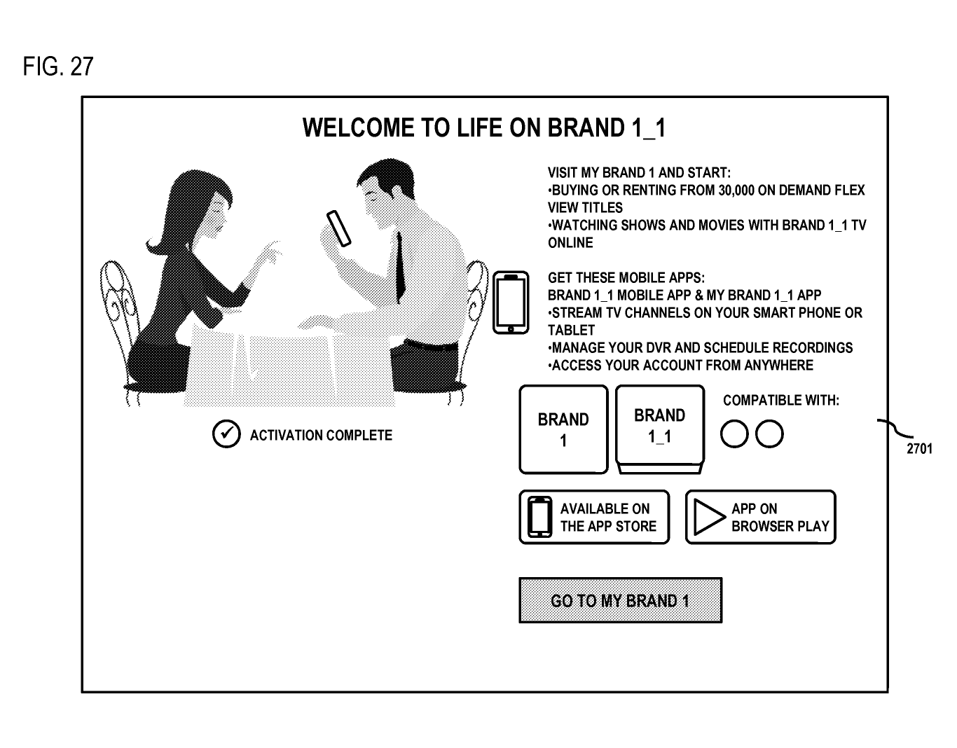

In one embodiment, the software setup module may be the last module in a self-install web based application. In one scenario, along with the ‘Continue’ CTA [2611], a ‘Feedback’ CTA [2613] may be displayed to collect the feedback on self-install web based application experience. In one scenario, once the user hits the ‘Continue’ CTA [2611] after the successful download and installation of the software, the user may be directed to a welcome page [FIG. 27] which may indicate the user that he has completed the process and can actively start using the products. In a further scenario, the welcome page [2701] may also hold place for promotional products.

The computer system 2800 may be coupled via the bus 2801 to a display 2811, such as a cathode ray tube (CRT), liquid crystal display, active matrix display, or plasma display, for displaying information to a computer user. An input device 2813, such as a keyboard including alphanumeric and other keys, is coupled to the bus 2801 for communicating information and command selections to the processor 2803. Another type of user input device is a cursor control 2815, such as a mouse, a trackball, or cursor direction keys, for communicating direction information and command selections to the processor 2803 and for controlling cursor movement on the display 2811.

According to an embodiment of the invention, the processes described herein are performed by the computer system 2800, in response to the processor 2803 executing an arrangement of instructions contained in main memory 2805. Such instructions can be read into main memory 2805 from another computer-readable medium, such as the storage device 2809. Execution of the arrangement of instructions contained in main memory 2805 causes the processor 2803 to perform the process steps described herein. One or more processors in a multi-processing arrangement may also be employed to execute the instructions contained in main memory 2805. In alternative embodiments, hard-wired circuitry may be used in place of or in combination with software instructions to implement the embodiment of the invention. Thus, embodiments of the invention are not limited to any specific combination of hardware circuitry and software.

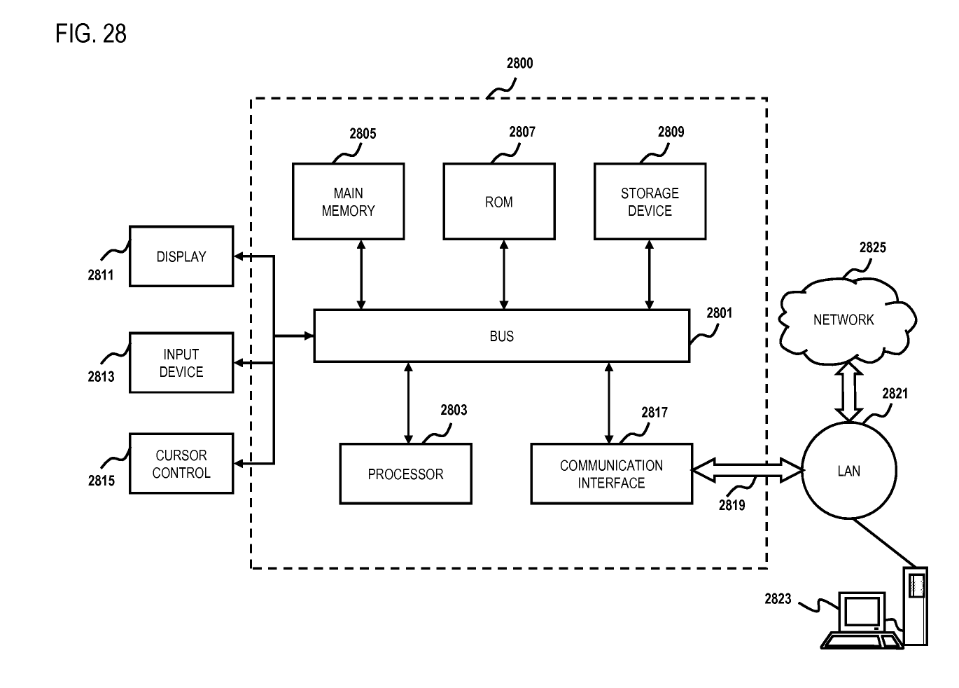

The computer system 2800 also includes a communication interface 2817 coupled to bus 2801. The communication interface 2817 provides a two-way data communication coupling to a network link 2819 connected to a local network 2821. For example, the communication interface 2817 may be a digital subscriber line (DSL) card or modem, an integrated services digital network (ISDN) card, a cable modem, a telephone modem, or any other communication interface to provide a data communication connection to a corresponding type of communication line. As another example, communication interface 2817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 2817 sends and receives electrical, electromagnetic, or optical signals that carry digital data streams representing various types of information. Further, the communication interface 2817 can include peripheral interface devices, such as a Universal Serial Bus (USB) interface, a PCMCIA (Personal Computer Memory Card International Association) interface, etc. Although a single communication interface 2817 is depicted in FIG. 28, multiple communication interfaces can also be employed.

The network link 2819 typically provides data communication through one or more networks to other data devices. For example, the network link 2819 may provide a connection through local network 2821 to a host computer 2823, which has connectivity to a network 2825 (e.g. a wide area network (WAN) or the global packet data communication network now commonly referred to as the “Internet”) or to data equipment operated by a service provider. The local network 2821 and the network 2825 both use electrical, electromagnetic, or optical signals to convey information and instructions. The signals through the various networks and the signals on the network link 2819 and through the communication interface 2817, which communicate digital data with the computer system 2800, are exemplary forms of carrier waves bearing the information and instructions.

The computer system 2800 can send messages and receive data, including program code, through the network(s), the network link 2819, and the communication interface 2817. In the Internet example, a server (not shown) might transmit requested code belonging to an application program for implementing an embodiment of the invention through the network 2825, the local network 2821 and the communication interface 2817. The processor 2803 may execute the transmitted code while being received and/or store the code in the storage device 2809, or other non-volatile storage for later execution. In this manner, the computer system 2800 may obtain application code in the form of a carrier wave.

The term “computer-readable medium” as used herein refers to any medium that participates in providing instructions to the processor 2803 for execution. Such a medium may take many forms, including but not limited to non-volatile media, volatile media, and transmission media. Non-volatile media include, for example, optical or magnetic disks, such as the storage device 2809. Volatile media include dynamic memory, such as main memory 2805. Transmission media include coaxial cables, copper wire and fiber optics, including the wires that comprise the bus 2801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

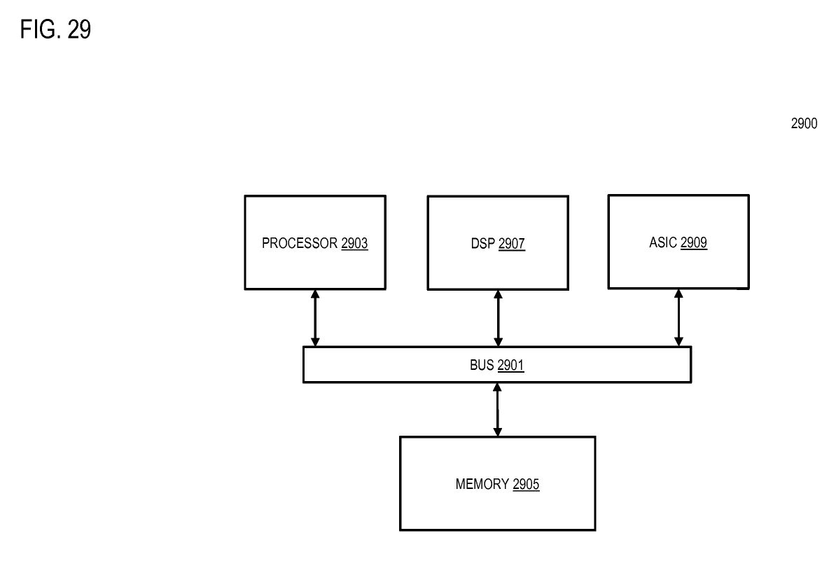

FIG. 29 illustrates a chip set 2900 upon which an embodiment of the invention may be implemented. Chip set 2900 is programmed to present a slideshow as described herein and includes, for instance, the processor and memory components described with respect to FIG. 29 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 2900, or a portion thereof, constitutes a means for performing one or more steps of FIGS. 3-6.

In one embodiment, the chip set 2900 includes a communication mechanism such as a bus 2901 for passing information among the components of the chip set 2900. A processor 2903 has connectivity to the bus 2901 to execute instructions and process information stored in, for example, a memory 2905. The processor 2903 may include one or more processing cores with each core configured to perform independently. A multi-core processor enables multiprocessing within a single physical package. Examples of a multi-core processor include two, four, eight, or greater numbers of processing cores. Alternatively or in addition, the processor 2903 may include one or more microprocessors configured in tandem via the bus 2901 to enable independent execution of instructions, pipelining, and multithreading. The processor 2903 may also be accompanied with one or more specialized components to perform certain processing functions and tasks such as one or more digital signal processors (DSP) 2907, or one or more application-specific integrated circuits (ASIC) 2909. A DSP 2907 typically is configured to process real-world signals (e.g., sound) in real time independently of the processor 2903. Similarly, an ASIC 2909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 2903 and accompanying components have connectivity to the memory 2905 via the bus 2901. The memory 2905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 2905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving a request to present a user interface for facilitating an installation of a device, a service, or a combination thereof;
retrieving user account information associated with the installation, wherein the user account information indicates the device, the service, or a combination thereof selected by a user; and
configuring one or more user interface elements of the user interface based on the user account information, the selected device, the selected service, or a combination thereof,
wherein the one or more user interface elements include a header section, a progress navigation section, a content section, a footer section, or a combination thereof.

2. A method of claim 1, wherein the device, the service, or a combination thereof is associated with a phone service, an internet service, a television service, a network service, or a combination thereof.

3. A method of claim 1, further comprising:
configuring the user interface, the one or more elements, or a combination thereof based on a progress of the installation.

4. A method of claim 3, further comprising:
determining the progress based on at least one of (a) a user input; (b) a network determined status of the installation, the device, the service, or a combination thereof; or (c) a combination thereof.

5. A method of claim 1, further comprising:
rendering one or more graphical representations, one or more textual representations, one or more audio representations, or a combination to indicate the device, the service, an installation instruction, an installation status, or a combination in the user interface, the one or more user interface elements, or a combination thereof.

6. A method of claim 1, further comprising:
rendering a user interface to provide installation instructions to a user for facilitating an installation of a device, a service, or a combination thereof; and
configuring a help screen as a user interface element of the user interface providing installation instructions,
wherein the help screen includes an instant messaging chat session.

7. A method of claim 1, further comprising:
rendering a user interface element of the user interface for providing error notification during a user verification process for device installation based on user account information,
wherein user account information include a preset username and password combination, a pin code, one or more identifiers, other authentication mechanisms, or a combination thereof.

8. A method of claim 7, further comprising:
rendering a user interface element of the user interface for requesting additional user information upon detecting an error during a user verification process for device installation.

9. A method of claim 1, further comprising:
configuring a catalog interface as a user interface element of the user interface to allow a user to identify one or more devices,
wherein a catalog interface includes device images, device names, device model numbers, device serial numbers, or a combination thereof.

10. An apparatus comprising a processor configured to:
receive a request to present a user interface for facilitating an installation of a device, a service, or a combination thereof;
retrieve user account information associated with the installation, wherein the user account information indicates the device, the service, or a combination thereof selected by a user; and
configure one or more user interface elements of the user interface based on the user account information, the selected device, the selected service, or a combination thereof,
wherein the one or more user interface elements include a header section, a progress navigation section, a content section, a footer section, or a combination thereof.

11. An apparatus of claim 10, wherein the device, the service, or a combination thereof is associated with a phone service, an internet service, a television service, a network service, or a combination thereof.

12. An apparatus of claim 10, further comprising:
configure the user interface, the one or more elements, or a combination thereof based on a progress of the installation.

13. An apparatus of claim 12, further comprising:
determine the progress based on at least one of (a) a user input; (b) a network determined status of the installation, the device, the service, or a combination thereof; or (c) a combination thereof.

14. An apparatus of claim 10, further comprising:
render one or more graphical representations, one or more textual representations, one or more audio representations, or a combination to indicate the device, the service, an installation instruction, an installation status, or a combination in the user interface, the one or more user interface elements, or a combination thereof.

15. An apparatus of claim 10, further comprising:
render a user interface to provide installation instructions to a user for facilitating an installation of a device, a service, or a combination thereof; and
configure a help screen as a user interface element of the user interface providing installation instructions,
wherein the help screen includes an instant messaging chat session.

16. An apparatus of claim 10, further comprising:
render a user interface element of the user interface for providing error notification during a user verification process for device installation based on user account information,
wherein user account information include a preset username and password combination, a pin code, one or more identifiers, other authentication mechanisms, or a combination thereof.

17. An apparatus of claim 16, further comprising:
render a user interface element of the user interface for requesting additional user information upon detecting an error during a user verification process for device installation.

18. An apparatus of claim 10, further comprising:
configure a catalog interface as a user interface element of the user interface to allow a user to identify one or more devices,
wherein a catalog interface includes device images, device names, device model numbers, device serial numbers, or a combination thereof.

19. A system comprising a platform configured to:
receive a request to present a user interface for facilitating an installation of a device, a service, or a combination thereof;
retrieve user account information associated with the installation, wherein the user account information indicates the device, the service, or a combination thereof selected by a user; and
configure one or more user interface elements of the user interface based on the user account information, the selected device, the selected service, or a combination thereof,
wherein the one or more user interface elements include a header section, a progress navigation section, a content section, a footer section, or a combination thereof.

20. A system of claim 19, wherein the platform is further configured to:
configure the user interface, the one or more elements, or a combination thereof based on a progress of the installation.

21. A system of claim 20, wherein the platform is further configured to:
determine the progress based on at least one of (a) a user input; (b) a network determined status of the installation, the device, the service, or a combination thereof; or (c) a combination thereof.

22. A system of claim 19, wherein the platform is further configured to:
render one or more graphical representations, one or more textual representations, one or more audio representations, or a combination to indicate the device, the service, an installation instruction, an installation status, or a combination in the user interface, the one or more user interface elements, or a combination thereof.
